(19) United States
(12) Patent Application Publication
(10) Pub. No.: US 2023/0196204 A1
(43) Pub. Date: Jun. 22, 2023

(54) AGNOSTIC MACHINE LEARNING INFERENCE

(71) Applicant: ALEGION, INC., Austin, TX (US)

(72) Inventors: Ryan Michael McKay, Austin, TX (US); Fountain L. Ray, III, Austin, TX (US); Cheryl Elizabeth Martin, Austin, TX (US)

(21) Appl. No.: 18/083,066

(22) Filed: Dec. 16, 2022

Related U.S. Application Data
(60) Provisional application No. 63/290,558, filed on Dec. 16, 2021.

(51) Int. Cl. G06N 20/00

(52) U.S. Cl. CPC G06N 20/00

(57) ABSTRACT

Systems, methods, and computer program products for agnostic machine learning inference are provided. A computer system, such as a labeling platform, uses a machine learning (ML) model inference configuration to configure an inference environment to use an ML model to process labeling requests. The ML model inference configuration is agnostic to the particulars of the ML platform being used. An adapter maps the ML model inference configuration to an ML platform specific format to instantiate a running system on a given platform.

### RELATED APPLICATIONS

This application claims the benefit of priority under 35 U.S.C. 119(e) to U.S. Provisional Patent Application No. 63/290,558, entitled “Agnostic Machine Learning Inference,” filed Dec. 16, 2021, which is hereby fully incorporated by reference herein.

### TECHNICAL FIELD

Embodiments of the present disclosure relate to machine learning inference.

### BACKGROUND

Machine learning (ML) techniques enable a machine to learn to automatically and accurately make predictions based on historical observation. Training an ML algorithm involves feeding the ML algorithm with training data to build an ML model. The accuracy of a ML model depends on the quantity and quality of the training data used to build the ML model.

An entire industry has developed around providing platforms for training ML models and using ML models for inference. Often, end users do not know what platforms and ML algorithms are best for which types of labeling tasks. Moreover, if an end user wishes to test multiple ML platforms or ML algorithms for labeling, the user must develop detailed configurations for each ML platform and algorithm.

### SUMMARY

Embodiments described herein provide a labeling platform that can leverage various machine learning (ML) integrations (platforms, frameworks, or algorithms). The labeling platform abstracts the configuration process such that an end user may specify an inference configuration for an ML model that is agnostic to the platform or framework in which the ML model used for inference is deployed.

The inference configuration for the ML model can include a variety of configuration information. According to one embodiment, the ML model inference configuration characterizes the expected label space for inferences produced by the ML model or a model-based labeler. The ML model inference configuration configures input and output transformations required to interact with the model itself. An input-conditioning configuration describes how to transform data to be labeled—images, for example—into a format understood by the model. A target-deconditioning may describe, for example, how to transform the raw model output (e.g., a numeric category index) into one of the labels listed in the label space. The ML model inference configuration may also include a request pipe configuration for the routing of inference requests and a result pipe configuration for routing of inference results (inferences). The ML model inference configuration is agnostic to the particulars of the ML platform being used. An adapter maps the ML model inference configuration to an ML platform specific format to instantiate a running system on a given platform.

One embodiment includes a computer implemented method, the computer-implemented method comprising defining a use case type at a labeling platform and associating a plurality of ML platforms with the use case type. The method may also include providing a set of adapters to map an ML platform agnostic format to a plurality of ML platform specific formats. The method may further include receiving, at the labeling platform, a use case associated with the use case type, the use case comprising an ML model inference configuration, wherein the ML model inference configuration is agnostic as to the ML model platform in which the ML model is deployed for inference.

The method may further include mapping the ML model inference configuration to a first inference environment to configure the first inference environment to use a first ML model, where the first inference environment is provided by a first ML platform from the plurality of ML platforms. The method may further include routing labeling requests to the first inference environment for labeling by the first ML model.

According to some embodiments, the method includes selecting an adapter from the plurality adapters, where the selected adapter maps the agnostic format to a platform specific format of the first ML platform. Mapping the ML model inference configuration to a first inference environment to configure the first inference environment to use a first ML model may include using the selected adapter to map the ML model inference configuration to the platform specific format of the first ML platform to configure the first inference environment to use the ML model.

Another embodiment comprises a computer program product for ML platform agnostic inference configuration. The computer program product comprises a non-transitory, computer-readable medium having stored thereon a set of computer executable instructions. The set of computer-executable instructions include instructions for associating a plurality of ML platforms with a defined use case type, mapping an ML platform agnostic format to a plurality of ML platform specific formats, and receiving a use case associated with the use case type. The use case may include an ML model inference configuration, where the ML model inference configuration is ML platform agnostic. The set of computer-executable instructions may include instructions for mapping the ML model inference configuration to a first inference environment to configure the first inference environment to use a first ML model, where the first inference environment provided by a first ML platform from the plurality of ML platforms. The set of computer-executable instructions may further include instructions for routing labeling requests to the first inference environment for labeling by the first ML model.

According to some embodiments, the set of computer-executable instructions may include instructions for selecting an adapter from a plurality of adapters, where the plurality of adapters map the ML platform agnostic format to ML platform specific formats of the plurality of ML platforms and where the selected adapter maps the ML platform specific format to the platform specific format of the first ML platform. Mapping the ML model inference configuration to the first inference environment to configure the first inference environment to use a first ML model may include using the selected adapter to map the ML model inference configuration to the platform specific format of the first ML platform.

Another embodiment includes a labeling platform that includes a use case type, an association of a plurality of ML platforms to the use case type, a set of adapters to map an ML platform agnostic format to a plurality of ML platform specific formats, a processor, and a non-transitory computer readable medium having stored thereon a set of computer-executable instructions. The set of computer-executable instructions may include instructions for receiving a use case associated with the use case type. The use case may include an ML model inference configuration, where the ML model inference configuration is ML platform agnostic. The set of computer-executable instructions may include instructions for mapping the ML model inference configuration to a first inference environment to configure the first inference environment to use a first ML model and for routing labeling requests to the first inference environment for labeling by the first ML model. The first inference environment is provided by a first ML platform from the plurality of ML platforms.

The set of computer-executable instructions may include instructions for selecting an adapter from the plurality of adapters. Mapping the ML model inference configuration to a first inference environment to configure the first inference environment to use the first ML model may comprise the labeling platform using the selected adapter to map the ML model inference configuration from the ML platform agnostic format to the ML platform specific format used by the first ML platform.

Some embodiments may include one or more of the following features. The ML model inference configuration may include a declaration of an ML algorithm, where the first inference environment may be selected from among several that support the first ML model. Mapping the ML model inference configuration to a second inference environment to configure the second inference environment to use a second ML model and routing labeling requests to the second inference environment for labeling by the second ML model. Routing the labeling requests to the second inference environment. Switching from routing labeling requests from the first inference environment to routing the labeling request to the second inference environment based on a determination that the second ML model is more accurate than the first ML model for the use case. The second inference environment may be provided by a second ML platform of the plurality of ML platforms associated with the use case type. Selecting an a second adapter, where the second adapter maps the ML platform agnostic format to the ML platform specific format of the second ML platform, where mapping the ML model inference configuration to the second inference environment to configure the second inference environment to use a second ML model includes using the second adapter to map the ML model inference configuration to the ML specific format of the second ML platform. The ML model inference configuration characterizing an expected label space for inferences. The ML model inference configuration comprising one or more of: an input conditioning configuration, a target deconditioning configuration, a request pipe configuration, a result pipe configuration, or a target conditioning configuration.

Further, embodiments may include related systems and computer program products. According to some embodiments, the computer-implemented method may be embodied as a set of software instructions stored on a non-transitory, computer-readable medium, the set of software instructions executable to cause a computer system to perform the computer-implemented method.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of one embodiment of a labeling environment;

FIG. 2 is a diagrammatic representation of one embodiment of a labeler;

FIG. 3 is a diagrammatic representation of a detailed view of one embodiment of a labeler;

FIG. 4 is a diagrammatic representation of one embodiment of processing by a human labeler;

FIG. 5 is a diagrammatic representation of one embodiment of a ML labeler;

FIGS. 6A and 6B are diagrammatic representations of one embodiment of an ML labeler architecture and a method for optimizing the performance of a labeling model in the architecture;

FIG. 7 is a diagrammatic representation of a conditioning pipeline and labeler kernel core logic for one embodiment of an image classification labeler;

FIG. 8 is a diagrammatic representation of one embodiment of a labeler configured to decompose an input request;

FIG. 9 is a diagrammatic representation of another embodiment of a labeler configured to decompose an input request

FIG. 10 is diagrammatic representation of one embodiment of a labeler configured to decompose an output space;

FIG. 11A, FIG. 11B, FIG. 11C, FIG. 11D illustrate one embodiment of platform services and flows;

FIG. 12 is a diagrammatic representation of one embodiment of configuring a labeling platform;

FIG. 13A and FIG. 13B are diagrammatic representations of a declarative configuration for one embodiment of an ML labeler;

FIG. 14 is a diagrammatic representation of a declarative configuration for one embodiment of a human labeler;

FIG. 15 is a diagrammatic representation of a declarative configuration for one embodiment of a CDW labeler;

FIG. 16 is a diagrammatic representation of one embodiment of configuring a labeling platform.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

There are many platforms, frameworks, and algorithms available for machine learning (ML) model training and inference. By way of example, but not limitation, an ML model may be trained in a DOCKER container (e.g., a DOCKER container containing libraries to train a model, or on a platform such as AMAZON SAGEMAKER, GOOGLE AUTOML, KUBEFLOW (SAGEMAKER from Amazon Technologies, Inc., AUTOML from Google, DOCKER by Docker, Inc.). In addition, there are various model frameworks that can be used (e.g., TENSORFLOW by Google, PyTorch, and MXNet). Further there are many ML algorithms (e.g., K-Means, Logistic Regression, Support Vector Machines, Bayesian Algorithms, Perceptron, Convolutional Neural Networks). Finally, for each combination of platform, framework, and algorithm, there are many data transformations and configuration parameters that may be applied to the training process with the goal of increasing trained model quality, reducing the volume of labeled training data required, reducing the computational resources required to train, etc. These configuration options are commonly referred to as hyper-parameters, and experimentation is often used to find optimal values. Training a model typically requires in-depth knowledge of ML platforms, frameworks, algorithms, as well as data transformation options and techniques, and configuration options associated with all the above.

Similarly, there are multiple platform options for using a model for inference. Further, there are multiple ways to interact with a model once it is trained. For example, some ML model APIs support submitting labeling requests one at a time, whereas other APIs support batches of labeling requests.

Thus, as will be appreciated, there are many options available for training ML models or using ML models for inference. Embodiments described herein provide a labeling platform that can leverage various ML integrations (platforms, frameworks, or algorithms). The labeling platform abstracts the configuration process such that an end user may specify an inference configuration for an ML model that is agnostic to the platform, framework or algorithm which will be used for inference.

According to one aspect of the present disclosure, a labeling platform allows a user (a “configurer”) to configure use cases, where each use case describes the configuration of a labeling platform for processing labeling requests. Use case configuration can include, for example, specifying labeler kernel core logic and conditioning components to use, configuring active learning aspects of the platform, configuring conditional logic (the ability to control the flow of judgments as they progress through stages), configuring labeling request distribution and configuring other aspects of the labeling platform.

According to another aspect of the present disclosure, the labeling platform provides a highly flexible mechanism to configure a labeling platform for a use case where the use case is used to implement a processing graph that includes one or more human labelers, ML labelers and/or other labelers. When a task is distributed to a human specialist, the platform can stop processing at a node of the graph to wait for a response from the human specialist and then continue processing based on the response. In some cases, a configuration can define a processing graph in which the labeled data provided by an ML labeler or human labeler (or other labeler in the processing graph) is looped back as training data into an ML labeler of the processing graph.

Configuration can be specified in any suitable format. In some embodiments, at least a portion of the configuration is expressed using a declarative Domain Specific Language (DSL). Thus, a configuration can be implemented using a declarative model that is human-readable and machine-readable, where the declarative model provides the definition of a processing system for a use case.

According to another aspect of the present disclosure, the labeling platform includes use case templates for various types of labeling problems (e.g., image classification, video classification, natural language processing, entity recognition, etc.). Use case templates make assumptions regarding what should be included in a configuration for a use case, and therefore require the least input from the human configurer. The platform can provide a more data driven and use case centric engagement with the end-user than prior labeling approaches. For example, according to one embodiment, the end-user selects the type of problem they have (e.g., image classification, natural language processing, or other problem class supported by the platform), provides information about the data they will provide, defines a small set of constraints (e.g., time, cost, quality) and specifies what data/labels they want back. According to one aspect of the present disclosure, the platform can store a declarative model for a use case, where the declarative model includes configuration assumptions specified by a use case template and the relatively small amount of configuration provided by the human user.

As discussed above, the labeling platform may provide a set of use case templates, where each use case template corresponds to a labeling problem to be solved (e.g., “image classification,” “video frame classification,” etc.) and includes an ML labeler configuration. The end user of a labeling platform may select a labeling problem (e.g., select a use case template), provide a minimum amount of configuration and provide data to be labeled according to the use case. The use case template can specify which ML platform, ML framework, ML algorithm, data transformations, and hyper-parameter values to use for ML model inference for a problem type. In some cases, the labeling platform specifies a priori the platforms, frameworks, algorithms, data transformations, and hyper-parameter values used to train ML models for a labeling problem. In some embodiments, the labeling platform may specify some number of platforms, frameworks, algorithms, data transformations, and hyper-parameter values to use and the labeling platform can experiment using data provided by the end user to find the best combination to use for a use case.

At runtime, the labeling platform sets up the specified ML platform, framework, algorithm, data transformations, and hyper-parameter values to train an ML model using the training data provided by the end user or produced by the platform, selects an ML platform to use based, for example, on the use case (problem type) or ML algorithm specified. The end user does not need to know the details of the ML platform, framework, or algorithm. Instead, the labeling platform uses configuration provided by the use case template, as well as experimentation, to produce a high-quality trained model for that customer's use case. The labeling platform can route records associated with the use case to the trained ML model for inference.

In some embodiments, one or more ML platforms include generic models or models trained for a use case. At runtime, the labeling platform can route records to be labeled to the appropriate ML platform and ML model for inference. In some embodiments, the labeling platform may route data records for a use case to multiple ML platforms for inference by various models to determine, for example, the most accurate model to use and may continue routing requests to the most accurate model. The end-user does not need to know detailed information about the inference configuration.

Embodiments provide the advantage that the end user need only specify a small amount of configuration information for the labeling platform to train or select a model or platform for a use case. In some embodiments, the labeling platform may train or select for inference from multiple ML platforms, frameworks, algorithms, data transformations, and hyper-parameter values associated with the use case. The labeling platform may continually retrain the multiple models based on the configuration for the use case.

These and other aspects of a labeling platform may be better understood from the following description.

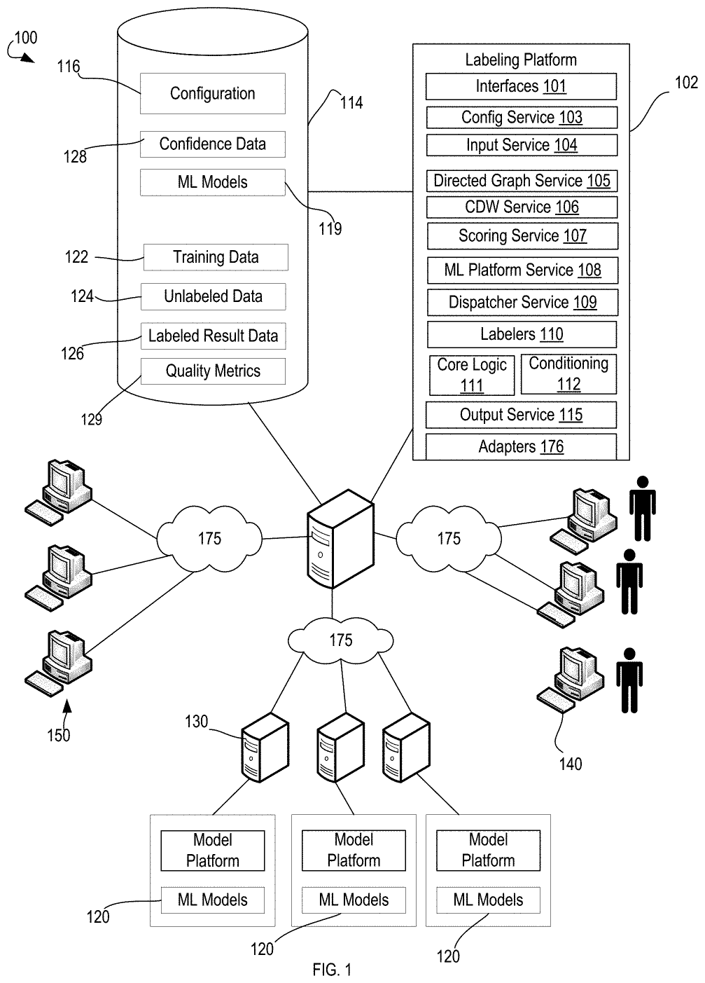

FIG. 1 is a diagrammatic representation of one embodiment of an environment 100 for labeling training data. In the illustrated embodiment, labeling environment 100 comprises a labeling platform system coupled through network 175 to various computing devices. Network 175 comprises, for example, a wireless or wireline communication network, the Internet or wide area network (WAN), a local area network (LAN), or any other type of communications link.

Labeling platform 102 executes on a computer—for example one or more servers—with one or more processors executing instructions embodied on one or more computer readable media where the instructions are configured to perform at least some of the functionality associated with embodiments of the present invention. These applications may include one or more applications (instructions embodied on a computer readable media) configured to implement one or more interfaces 101 utilized by labeling platform 102 to gather data from or provide data to ML platform systems 130, human labeler computer systems 140, client computer systems 150, or other computer systems. It will be understood that the particular interface 101 utilized in a given context may depend on the functionality being implemented by labeling platform 102, the type of network 175 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries, or other type of interface which it is desired to be utilized in a particular context.

In the embodiment illustrated, labeling platform 102 comprises a number of services including a configuration service 103, input service 104, directed graph service 105, confidence driven workflow (CDW) service 106, scoring service 107, ML platform service 108, dispatcher service 109 and output service 115. Labeling platform 102 further includes labeler core logic 111 for multiple types of labelers and conditioning components 112 for various types of data conditioning. As discussed below, labeler core logic 111 can be combined with conditioning components 112 to create labelers 110.

Labeling platform 102 utilizes a data store 114 operable to store obtained data, processed data determined during operation, and rules/models that may be applied to obtained data or processed data to generate further processed data. Data store 114 may comprise one or more databases, file systems, combinations thereof or other data stores. In one embodiment, data store 114 includes configuration data 116, which may include a wide variety of configuration data, including but not limited to configuration data for configuring directed graph service 105, labelers 110 and other aspects of labeling platform 102. Configuration data 116 may include “use cases”. In this context a “use case” is a configuration for a processing graph. In some embodiments, labeling platform 102 may provide use case templates to assist end-users in defining use cases. In the illustrated embodiment, labeling platform 102 also stores data to persist machine learning (ML) models (data 119), training data 122 used to train ML models 120, unlabeled data 124 to be labeled, confidence data 128, quality metrics data 129 (e.g., scores of labeler instances) and other data.

As discussed below, labeling platform 102 can distribute data to human users to be labeled. To this end, data labeling environment 100 also comprises human labeler computer systems 140 that provide user interfaces (UI) that present data to be labeled to human users and receive inputs indicating the labels input by the human users.

Labeling platform 102 also leverages ML models 120 to label data. Labeling platform 102 may implement its own ML platform or leverage external or third-party ML platforms, such as commercially available ML platforms hosted on ML platform systems 130. As such, data labeling environment 100 includes one or more ML platforms in which ML models 120 may be created, trained, and deployed. Labeling platform 102 can send data to be labeled to one or more ML platforms so that data can be labeled by one or more ML models 120.

Client computer systems 150 provide interfaces to allow end-users, such as agents or customers of the entity providing labeling platform 102, to create use cases and provide input data. According to one embodiment, end-users may define use cases, where a use case is a set of configuration information for configuring platform 102 to process unlabeled data 124. A use case may specify, for example, an endpoint for uploading records, an endpoint from which labeled records may be downloaded, an endpoint from which exceptions may be downloaded, a list of output labels, characteristics of the unlabeled data (e.g., media characteristics, such as size, format, color space), pipelines (e.g., data validation and preparation pipelines), machine learning characteristics (e.g., ML model types, model layer configuration, active learning configuration, training data configuration), confidence driven workflow configuration (e.g., target confidence threshold, constituent labelers, human specialist workforces, task templates for human input), cost and quality constraints or other information. According to some embodiments, at least a portion of a use case is persisted as a declarative model of the use case, where the declarative model describes a processing graph (labeling graph) for the use case at a logical level. Platform 102 may support a wide array of use cases.

Platform 102 may include a plurality of adapters 176 where each adapter is configured to map a configuration (e.g., a configuration expressed using a declaration Domain Specific Language) to an ML training and runtime (inference) environment and configure the environment. There may be any number of platforms, frameworks, or algorithms in a training or inference environment and thus, an adapter 176, may be capable of configuring various platforms, frameworks, or algorithms within an environment. An adapter 176 can be configured to connect to a remote ML platform system 130 and configure the ML platform to train a model according to a configuration. The adapter 176 may be further configured to route labeling requests to the environment for inference.

In operation, labeling platform 102 implements a use case to label the data. For example, the use case may point to a data source (such as a database, file, cloud computing container, etc.) and specify configurations for labelers to use to label the data. Directed graph service 105 uses the configurations for labelers and implements a directed graph of labelers 110 (e.g., to implement the use case) to label the data. In some cases, the labelers are implemented in a CDW to label the data and produce labeled result data 126, where the workflow incorporates one or more ML models and one or more human users to label the data. The CDW may itself be implemented as a directed graph.

During execution of a graph, the same data item to be labeled (e.g., image, video, word document, or other discrete unit to be labeled) may be sent to one or more ML labeling platforms to be processed by one or more ML models 120 and to one or more human labeler computer systems 140 to be labeled by one or more human users. Based on the labels output for the data item by one or more labelers 110, the workflow can output a final labeled result.

It can be noted that certain unlabeled data provided by the end user may be labeled by an oracle labeler, human users or otherwise labeled and then provided to an ML labeler to train one or more ML models. Training may occur based on the occurrence of one or more training triggers. In some embodiments, training and inference are parts of a continuous execution of the labeling graph. An ML model may be trained in an environment and remain in that environment for inference.

In some cases, training and inference may be more bifurcated. A trained ML model may be exported from the environment in which it was trained and stored as a data artifact in platform 102 (e.g., as an ML model 119 in data store 114). The trained ML model may be packaged and provided to the end user (e.g., as a DOCKER container) for deployment to the end user's environment or may be deployed by platform 102 for inference to a different environment from the environment in which it was trained.

The basic building blocks of the directed graph implemented by directed graph service 105 are “labelers.” As discussed below, some examples of labelers include, but are not limited to, executable code labelers, third-party hosted endpoint labelers, ML labelers and human labelers, and CDW labelers.

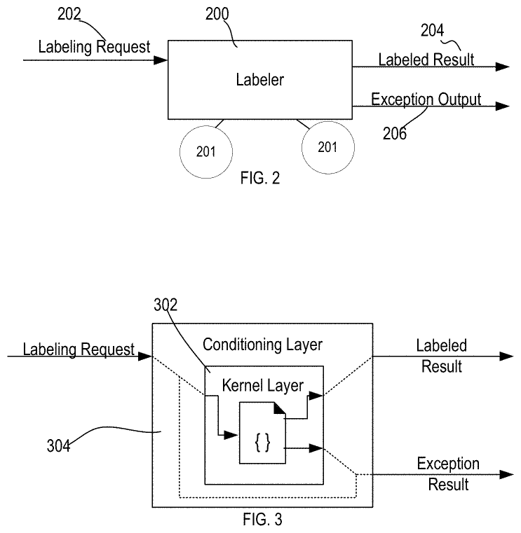

With reference to FIG. 2, labelers (e.g., labeler 200) take input and enrich the input with labels using one or more labeling instances 201. An element of input can be thought of as a labeling request, or question. Put another way, a labeling request may comprise an element to be labeled (e.g., image or other unit of data that can be labeled by the labeler). A labeled result can be thought of as an answer to that question or a judgment.

The input is fed to the labeler over an input pipe 202, and the labeled output is placed in an output pipe 204. Inputs that the labeler fails to label are placed in an exception output pipe (exception pipe) 206. Some exceptions may be recoverable. These three pipes can pass both data and labeling flow control. Each of these pipes can have a configurable expected data schema.

A labeling request may have associated flow control data, such as constraints on allowable confidence and cost (time, monetary or other cost), a list of labeling instances to handle or not handle the request or other associated flow control information to control how the labeler 200 handles the request. Labeled results from a labeler 200 are the result of running a conditioned labeling request through a labeler 200.

The answer (output labeled result) is passed through an output conditioning pipeline if one is specified for the labeler. The label output by a labeler may have many forms, such as, but not limited to: value output based on a regression model, a class label, a bounding box around an object in an image, a string of words that characterize/describe the input (e.g., “alt text” for images), an identification of segmentation (e.g., “chunking” a sentence into subject and predicate). In some cases, a labeler may also output a self-assessed confidence measure for a label. Labeler 200 may also output various other information associated with the labeled result, such as the labeler instance that processed the labeling request.

One embodiment of the internal structure of a labeler, such as labeler 200, is illustrated in FIG. 3. According to some embodiments, a labeler may be considered a wrapper on executable code. In some cases, the executable code may call out to third party hosted endpoints. Configuration can specify the endpoints to use, authentication information and other configuration information to allow the labeler to use the endpoint. In the illustrated embodiment, the labeler's kernel of core logic 302 is surrounded by a conditioning layer 304, which translates input/output data from an external domain to the kernel's native data domain. As will be appreciated, different labelers may have different kernel core logic 302 and conditioning layers 304. Some types of labelers may include additional layers.

In one embodiment, platform 102 includes human labelers and ML labelers. Human labelers and ML labelers may be combined into CDWs, which may also be considered a type of labeler. The kernel core logic 302 of a human labeler is configured to distribute labeling requests out to individual human specialists while the kernel core logic 302 of ML labelers is configured to leverage ML models to label data. As such, each human labeler and ML labeler may be considered an interface to a pool of one or more labeler instances behind it. A labeler is in charge of routing labeling requests to specific labeler instances within its pool. For a human labeler, the labeler instances are individual humans working through a user interface (e.g., human specialists). For an ML labeler, the labeler instances are ML models deployed in model platforms. The labeler instances may have different confidence metrics, time costs and monetary costs.

Translation by conditioning layer 304 may be required because the data domain external to the kernel core logic 302 may be different from the kernel's data domain. In one embodiment, for example, the external data domain may be use-case specific and technology agnostic, while the kernel's data domain may be technology-specific and use-case agnostic. The conditioning layer 304 may also perform validation on inbound data. For example, for one use case, a solid black image may be valid for training/inferring, while for other use cases, it may not. If it is not, the conditioning layer 304 may, for example, include a filter to remove solid black images. Alternatively, it might reject such input and issue an exception output.

The conditioning layer 304 of a labeler may include input conditioning, successful output conditioning, and exception output conditioning. Each of these can be constructed by arranging conditioning components into pipelines. Conditioning components perform operations such as data transformation, filtering, and (dis)aggregation. Similar to labelers, the conditioning component may have data input pipes, data output pipes, and exception pipes.

Multiple ML labelers, human labelers or other labelers can be composed together into directed graphs as needed, such that each individual labeler solves a portion of an overall classification problem, and the results are aggregated together to form the overall labeled output. The overall labeling graph for a use case can be thought of abstractly as a single labeler, and each labeler may itself be implemented as a directed graph. There may be branches, merges, conditional logic, and loops in a directed graph. Each directed graph may include a fan-in to a single output answer or exception per input element. The method of modeling the labeling in such embodiments can be fractal. The labeling graphs implemented for particular use cases may vary, with some graphs relying exclusively on ML labelers and other graphs relying solely on human labelers.

ML labelers and human labelers and/or other labelers may be implemented in a CDW, which can be considered a labeler that encapsulates a collection of other labelers. The encapsulated labelers are consulted in sequence until a configured threshold confidence on the answer is reached. A CDW can increase labeling result confidence by submitting the same labeling request to multiple constituent labelers and/or labeler instances. A CDW may include an ML labeler that can learn over time to perform some or all of a use case, reducing the reliance on human labeling, and therefore driving down time and monetary cost to label data.

Executable Code Labelers

Executable code labelers package up executable code with configurable parameters to be used as executable code labelers. The configuration for an executable code labeler includes any configuration information relevant to the executable code of the labeler. Other than the generic configuration information that is common to all labelers, the configuration for an executable labeler will be specific to the code. Examples of things that could be configured include, but are not limited to: S3 bucket prefix, desired frame rate, email address to be notified, batch size.

Third-Party Hosted Endpoint Labelers

A third-party hosted endpoint labeler can be considered a special case of an executable code labeler, where the executable code calls out to a third-party hosted endpoint. The configuration of the third-party hosted endpoint can specify which endpoint to hit (e.g., endpoint URL), auth credentials, timeout, etc.

Human Labelers

A human labeler acts as a gateway to a human specialist workforce. A human labeler may encapsulate a collection of human specialists with similar characteristics (cost/competence/availability/etc.) as well as encapsulating the details of routing requests to the individual humans and routing their results back to the labeling system. Human labelers package the inbound labeling request with configured specialist selection rules and a task UI specification into a task.

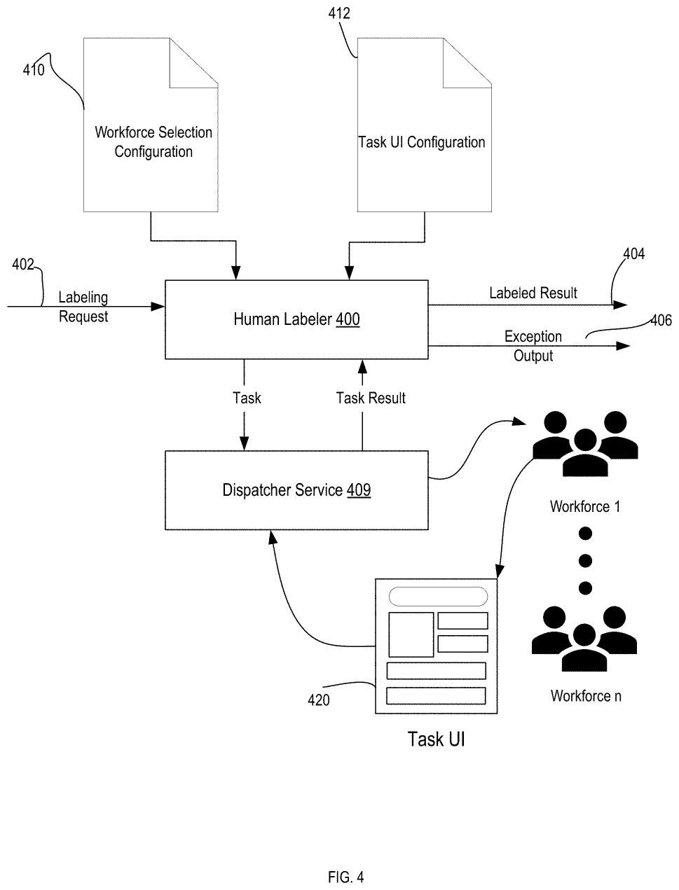

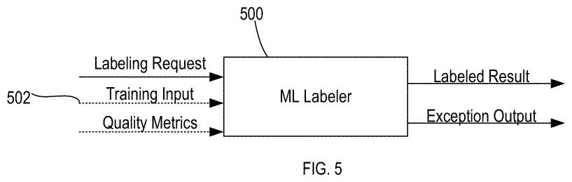

FIG. 4 illustrates one embodiment of processing by a human labeler 400. In the illustrated embodiment, human labeler 400 receives a labeling request on input pipe 402 and outputs a labeled result on an output pipe 404. Exceptions are output on exception pipe 406. As discussed above, human labeler 400 may include a conditioning layer to condition labeling requests and answers.

Human labeler 400 is configured according to a workforce selection configuration 410 and a task UI configuration 412. Workforce selection configuration 410 provides criteria for selecting human specialists to which a labeling request can be routed. Workforce selection configuration 410 can include, for example, platform requirements, workforce requirements and individual specialist requirements. In some embodiments, platform 102 can send tasks to human specialists over various human specialist platforms (e.g., Amazon Mechanical Turk marketplace and other platforms). Workforce selection configuration 410 can thus specify the platform(s) over which tasks for the labeler can be routed. Human specialist platforms may have designated workforces (defined groups of human specialists). Workforce selection configuration 410 can specify the defined groups of human specialists to which tasks from the labeler can be routed (i.e., groups of human labeler instances to whom labeling tasks can be routed). If a workforce is declared in configuration 410 for a use case, a human specialist must be a member of that workforce for tasks for the labeler 400 to be routed to that human specialist. Workforce selection configuration 410 may also specify criteria for the individual specialists to be routed a task for labeler 400. By way of example, but not limitation, workforce selection configuration 410 can include a skill declaration that indicates the skills and minimum skill scores that individual workers (human specialists) must have to be routed labeling tasks from the labeler. A quality monitoring subsystem (QMS) may track skills/skill scores for individual human specialists.

Task UI configuration 412 specifies a task UI to use for a labeling task and the options available in the UI. According to one embodiment, a number of task templates can be defined for human labeler specialists with each task template expressing a user interface to use for presenting a labeling request to a human for labeling and receiving a label assigned by the human to the labeling request. Task UI configuration 412 can specify which template to use and the labeling options to be made available in the task UI.

When labeler 400 receives a labeling request, labeler 400 packages the labeling request with the workforce selection configuration 410 and task UI configuration 412 as a labeling task and sends the task to dispatcher service 409 (e.g., dispatcher service 109). Dispatcher service 109 is a highly scalable long-lived service responsible for accepting tasks from many different labelers and routing them to the appropriate endpoint for human specialist access to the task. Once a worker accepts a task, the platform (e.g., the dispatcher service) serves the configured browser-based task UI 420, then accepts the task result from the specialist and validates it before sending it back to the labeler.

The same labeling request may be submitted multiple times to a single human labeler. In some embodiments however, it is guaranteed not to be presented to the same human specialist (labeler instance) more than once. Human-facing tasks can also support producing an exception result, with a reason for the exception.

Machine-Learning Labelers

As discussed above, labeling platform 102 may implement ML labelers. FIG. 5 is a diagrammatic representation of an ML labeler. The core logic of an ML labeler may implement an ML model or connect to an ML framework to train or utilize an ML model in the framework. Because the model used by the ML labeler can be retrained, the ML labeler can learn over time to perform some or all of a use case.

As illustrated in FIG. 5, an ML labeler utilizes two additional input pipes for training data and quality metrics, which participate in its training flow. Thus, the pipes can be connected to the kernel code (e.g., kernel core logic 302) of the ML labeler 500, similar to the input pipe illustrated in FIG. 3.

At a high level, ML training and inference can be thought of as a pipeline of five functional steps: Input Data Acquisition, Input Data Conditioning, Training, Model Deployment, and Model Inference.

According to one embodiment, the acquisition of unlabeled data for labeling and labeled data for training is handled by platform 102, as opposed to within the labeler 500 itself. The data may be passed in directly over an endpoint, streamed in via a queue like SQS or Kafka, or provided as a link to a location in a blob store. The labeler can use simple standard libraries to access the data.

Data may be transformed to prepare the data for training and/or inference. Frequently some amount of transformation will be required from raw input data to trainable/inferable data. This may include validity checking, image manipulation, aggregation, etc. As would be appreciated by those in the art, the transformations can depend on the requirements of the ML model being trained or used for inference.

Training (and retraining) is the process by which conditioned training data is converted into an executable model or a model is retrained. The output of training is an ML model that represents the best model currently producible given the available training data. It can be noted that in some embodiments, such as embodiments utilizing ensemble approaches, an ML labeler may use multiple models produced from training.

Training data enters the ML labeler 500 through its training data input pipe 502. This pipe, according to one embodiment, transfers data only, not labeling flow control. The schema of the training data input pipe is the same as the labeled output pipe. As such, it may need conditioning in order to be consumable by the training process. In some embodiments, training data accumulates in a repository, but may be subject to configurable data retention rules.

In some cases, end user-provided data or a publicly available dataset may be used as a training dataset. New models can be trained as additional training data becomes available. In addition, or in the alternative, training data can come from an “oracle” labeler (e.g., an oracle ML labeler or oracle human labeler). The output of the oracle labeler is assumed to be correct, or at least the most correct to which platform 102 has access for a use case.

Training data augmentation may be used to bolster and diversify the training data corpus by adding synthetic training data. This synthetic training data can be based on applying various transforms to raw training data.

There are a variety of options for triggering training. The trigger may be as simple as a certain number of training data records accumulating, or a certain percentage change therein. A training trigger may also incorporate input from a quality control subsystem. Time since last training can also be considered.

Output labels from an ML labeler 500 are the result of running a conditioned label request through a deployed ML model to obtain an inferred answer. This inference may not be in a form that is directly consumable by the rest of the labeling graph (as specified by the output pipe schema), in which case it is passed through an output conditioning pipeline (e.g., in conditioning layer 304). According to one embodiment, the label result output by an ML labeler 500, includes the input label request, the inferred label, and a self-assessed confidence measure.

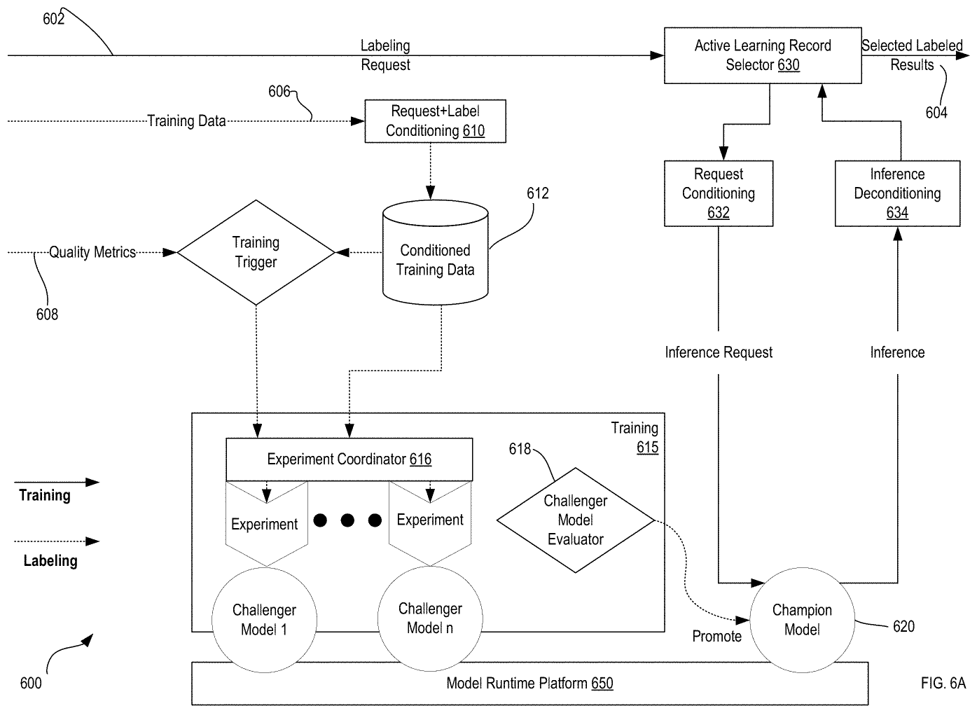

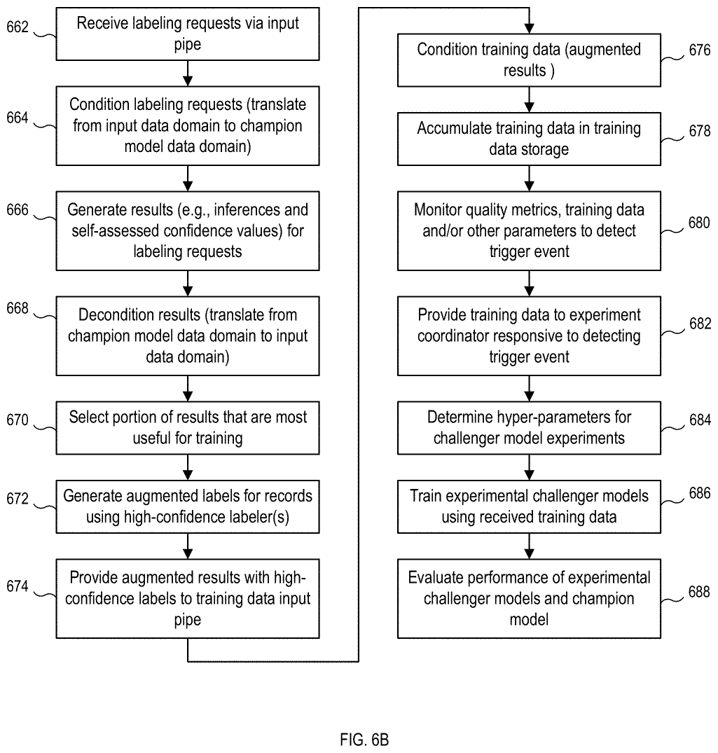

FIG. 6A is a diagrammatic representation of one embodiment of the functional components of a machine-learning labeler 500. An ML labeler configuration provided by a use case can specify a configuration of each of the functional components.

FIG. 6A also illustrates an example of data labeling and training flows. In the embodiment of FIG. 6A, the ML labeler 600 includes an input pipe 602, output pipe 604, training data input pipe 606 and a quality metrics input pipe 608. To simplify the diagram, the exception output pipe is not shown in FIG. 6A, but as will be appreciated, if any error condition is encountered in labeler execution, it is signaled out on the exception output pipe.

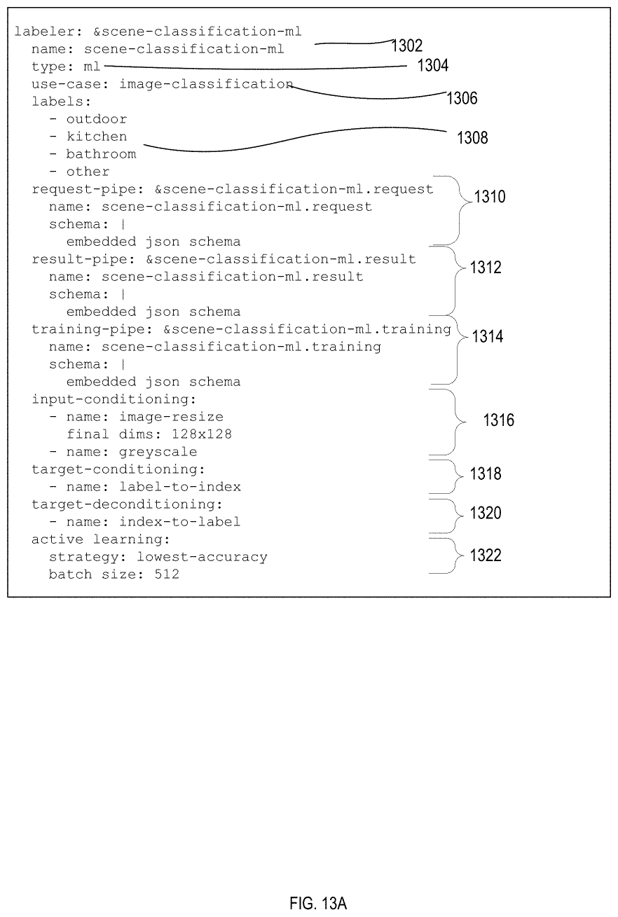

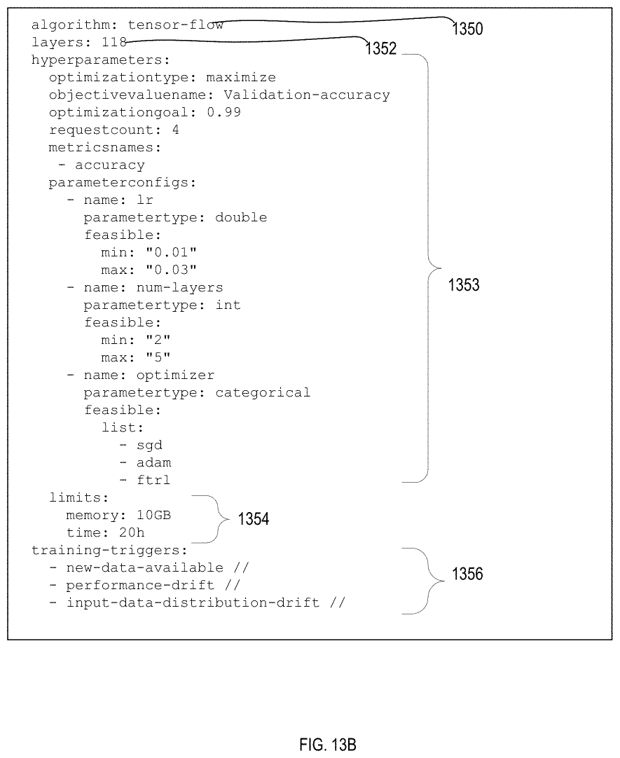

An ML labeler includes code to implement or utilize an ML model. In some embodiments, the ML labeler may be implemented as a wrapper for an ML model on a model runtime platform 650 running locally or on a remote ML platform system (e.g., an ML platform system 130). The ML labeler configuration (discussed in more detail below in connection with FIGS. 13A and 13B) can specify an ML algorithm to use. Based on the ML algorithm specified, labeling platform 102 configures the labeler with the code to connect to the appropriate ML model runtime platform 650 in order to train and use the specified ML algorithm.

The configuration for the ML labeler includes a general configuration and an ML labeler-type specific configuration. The ML labeler-type specific configuration can include an ML algorithm configuration, a training pipe configuration and a training configuration. The ML algorithm configuration specifies an ML algorithm or platform to use and other configuration for the ML algorithm or platform (layers to use, etc.). In some cases, a portion of the ML algorithm configuration may be specific to the ML algorithm or platform. The training configuration can include an active learning configuration, hyper-parameter ranges, limits, and triggers. A portion of the training configuration may depend on the ML algorithm or platform declared. The ML labeler configuration can also specify conditioning pipelines for the input, output, training, or exception pipes.

ML labeler 600 includes an active learning record selector 630 to select records for active learning. Configuring active learning record selector 630 may include, for example, specifying an active learning strategy (e.g., lowest accuracy, FIFO, or some other selection technique) and a batch size of records to pass along for further labeling and eventual use as training data for ML labeler 600.

According to one embodiment, active learning record selector 630 selects all unlabeled records (or some specified number thereof) for a use case (records that have not yet been labeled by the ML labeler) and has those labeled by the ML model 620. The ML model 620 evaluates its results (e.g., provides a confidence in its results). Active learning record selector 630 evaluates the results (for instance, it may evaluate the confidences associated with the results) and forwards some subset of the results to the other labelers in the graph and/or an oracle labeler for augmented labeling. The augmented labeling comprises generating labels for the associated images or other data which have confidences that meet specified criteria. The augmented labeling may result in a correction of the label associated with the images or other data, or the high-confidence label generated by the augmented labeling may be the same as the label generated by ML model 620. A subset of the results generated by ML model 620 may alternatively be determined to have sufficiently high confidences that no augmented labeling of these results is necessary. The selected records with their final, high-confidence (e.g., augmented) results are then provided as training data for the ML labeler (albeit potentially with a different result determined by the confidence-driven workflow than by ML model 620).

An ML labeler can include a conditioning layer that conditions data used by the ML labeler. Embodiments may include, for example, a request conditioning pipeline to condition input requests, an inference conditioning pipeline to condition labeled results and/or a training request and label conditioning pipeline for conditioning training data. Each conditioning pipeline, if included, may comprise one or more conditioning components. The ML labeler configuration can specify the conditioning components to be used for request conditioning, inference de-conditioning and training and request conditioning, and can specify how the components are configured (for example, the configuration can specify the size of image to which an image resizing component should resize images).

In the embodiment illustrated in FIG. 6A, ML labeler 600 includes a conditioning layer that includes components to condition labeling requests, inferences and training data. Request conditioning pipeline 632 conditions input labeling requests that are received via input pipe 602 by active learning record selector 630 to translate them from the data domain of active learning record selector 630 to the data domain of champion model 620. After champion model 620 generates inferences corresponding to the labeling requests, the inferences and labeling requests are deconditioned to translate them back to the data domain of active learning record selector 630.

The deconditioned labeling requests and inferences may be provided on output pipe 604 to a directed graph (not shown in the figure) that will function to reach a threshold confidence, generating a label with high confidence. This may include, but are not limited to, executable code labelers, third-party hosted endpoint labelers, ML labelers and human labelers, and CDW labelers. While some of the inferences generated by the champion model may have sufficiently high self-assessed confidence that they may be provided to customers or provided back to the system as training data, others will have lower associated confidences. These lower-accuracy labeling requests and inferences are processed by the high-confidence labeler(s) to generate high-accuracy labels, and the records with their corresponding high-confidence labels (e.g., augmented results) are provided on training data input pipe 606 to training request and label conditioning pipeline 610 as training data.

Training request and label conditioning pipeline 610 is provided for conditioning training data so that it can be used to train challenger ML models. Conditioned training data 612 is accumulated in a training data storage device and is retrieved from this storage device when needed to train one or more ML models. In this embodiment, training request and label conditioning pipeline 610 is part of the conditioning layer that further includes request conditioning pipeline 632 which conditions input requests, and inference conditioning pipeline 634 which conditions results (inferences) from the champion model. Each conditioning pipeline, if included, may comprise one or more conditioning components as specified in the ML labeler's configuration.

ML labeler 600 includes a training component 615 which is executable to train an ML algorithm. Training component 615 may be configured to connect to the appropriate ML model runtime platform 650 to train an ML algorithm to create an ML model. In this embodiment, training component 615 includes an experiment coordinator 616 that interfaces with model runtime platform 650 to train multiple challenger models. Each challenger model is configured using a corresponding set of hyperparameters or other mechanisms in order to train multiple, different candidate models (challenger models), each of which has its own unique characteristics that affect the labeling of requests. The ML labeler configuration may specify hyper-parameter ranges and limits to be used during training. Each of the challenger models therefore represents an experiment to determine the labeling performance which results from the different ML model configurations. The types of hyperparameters and other mechanisms used to train the candidate models may include those known in the art.

The ML labeler configuration can specify training triggers (trigger events), such that when the training component 615 detects a training trigger, the training component 615 initiates (re)training of the ML algorithm to determine a current active model. Training triggers may be based on, for example, an amount of training data received by the labeler, quality metrics received by the labeler, elapsed time or other criteria.

After the experiment coordinator trains the different candidate ML models, a challenger model evaluator 618 evaluates the candidate ML models against each other and against the current active model (the champion model) to determine which should be the current active model for inferring answers to labeling requests. This determination may be made on the basis of various different evaluation metrics that measure the performance of the candidate models. The determination may also take into account the cost of replacing the champion model (e.g., in some embodiments a challenger model may not be promoted to replace the champion model unless the performance of the challenger model exceeds that of the champion model by a threshold amount, rather than simply being greater than the performance of the champion model). The output of training component 615 is a champion ML model that represents the “best” model currently producible given the available training data and experimental configurations. The training component 615 thus determines the ML model to use as the current active model (the champion model) for inferring answers to labeling requests.

FIG. 6B is a diagrammatic representation of one embodiment of a method for optimizing an ML labeler model in the ML labeler of FIG. 6A.

As noted above, the ML labeler 600 operates to optimize the model that is used to generate inferences corresponding to the labeling requests. This process begins with labeling requests being received on the input pipe of the ML labeler (step 662). In this embodiment, the labeling requests are received by the active learning record selector, but this could be performed by another component in an alternative embodiment. The labeling requests can be characterized as defined by the configuration of the ML labeler, which is discussed in more detail below in connection with FIGS. 13A and 13B (see, e.g., FIG. 13A, 1310).

The labeling requests are provided by the active learning record selector to the request conditioning pipeline of the conditioning layer so that the labeling requests can be conditioned before they are provided to the champion model (step 664). In one embodiment, the conditioning consists of translating the labeling request from an original data domain to the data domain of the champion model so that the champion model will “understand” the labeling request (see, e.g., FIG. 13A, 1318, 1320). For example, a labeling request as input to the ML labeler may have an associated name, but the champion model may be configured to work with an index instead of a name. In this case, the conditioning pipeline will translate the name of the request to an index so that the request can be processed by the champion model. The conditioning may also involve operations such as resizing an image or converting the image from color to greyscale (see, e.g., FIG. 13A, 1316).

The conditioned requests are processed by the champion model to generate a result (an inference) for the request (step 666). In this embodiment, the champion model is also configured to generate a self-assessed confidence indicator, which is a value indicating a confidence level associated with the inference. The confidence indicator may indicate that the champion model has a high level of confidence associated with the generated inference (i.e., the model assesses the inference to be highly likely to be accurate), or it may indicate that the model has a lower level of confidence (i.e., the model assesses the inference to be less likely to be accurate). The processed request and the associated inference are provided with the confidence indicator to the deconditioning pipeline so that they can be translated from the champion models data domain back to the data domain of the original labeling request (step 668). The deconditioned requests and inferences are then provided to the active learning record selector.

The active learning record selector is configured to select a subset of the processed records to be used for purposes of training the challenger models and evaluating their performance against the champion model (step 670). The labeling requests are selected according to an active learning strategy which is determined by the configuration of the ML labeler. In some embodiments, for example, the labeler may implement strategies in which the records that are deemed to have the lowest accuracy, the lowest self-assessed confidence, or the lowest distributional representation in the current training data set may be selected for training (see, e.g., FIG. 13A, 1322). The implemented strategy may prescribe the selection of these records because they are the records for which the champion model has exhibited the poorest performance or self-assessed confidence and therefore represent the type(s) of records on which training should be focused in order to improve the performance of the model that is used to generate the inferences. In the example of FIG. 13A, the active learning record selector is configured to accumulate records and then select a designated number (e.g., 512) of the records to be further processed and used as training data. The selection strategy, number of selected requests, and various other parameters for selection of the requests are configurable according to the configuration of the ML labeler.

The records selected by the active learning record selector are provided to one or more high-accuracy labelers that may be part of a confidence-driven labeling service (step 672). The high-confidence labelers may include automated labelers and human labelers. The high-accuracy labelers generate a high-confidence label result for each of the records. Since the records were selected in this example as those having the lowest accuracy, the labels generated by the high-confidence labelers may well be different from the inferences generated by the champion model, but if the accuracy of the champion model itself is high, the generated labels may match the inferences of the champion model. When the high-confidence labels have been generated for the selected records, the generated label results are provided to the training data input pipe 606 so that they can be used for training and evaluation purposes (step 674).

The high-confidence label results input via the training data input pipe are provided to a training request and label conditioning pipeline 610, which performs substantially the same function as request conditioning pipeline 632 (step 676). The conditioned requests and corresponding labels are then stored as conditioned training data 612 in a training data storage device, where they may be accumulated for use by the training component of the ML labeler (step 678). In this embodiment, the requests and corresponding labels are stored until a trigger event is detected. The trigger event is detected by a training trigger that monitors information which may include quality metrics, the amount of training data that has been accumulated, or various other parameters (step 680). When the monitored information meets one or more conditions that define a trigger event, a portion of the accumulated training data is provided to the coordinator of the training component (step 682).

The trigger event is also used by the experiment coordinator of the training component to initiate one or more experiments, each of which uses a corresponding set of hyper-parameters to configure a corresponding challenger model (step 684). Each of the experimental challenger models is uniquely configured in order to develop unique challenger models which can be compared to the champion model to determine whether the performance of the champion model can be improved. Each of these experimental challenger models is trained using the same training data that is provided from the training data store to the experiment coordinator (step 686). The trained challenger models can then be evaluated to determine whether they should be promoted to replace the champion model.

After the experimental challenger models are trained using the first portion of the training data, they are evaluated using a second portion of training data which is reserved in the training data storage (step 688). Normally, the second portion of the data will not overlap with the first portion of the training data. Additionally, while the first portion of the data (which is used to train the challenger models) normally includes only recently stored training data, the second portion of the training data may include older, historical training data. The second portion of the training data is processed by each of the trained challenger models, as well as the champion model to generate corresponding results/inferences (step 688). The results of the different models are evaluated against each other to determine their respective performance. The evaluation may be multidimensional, with several different aspects of the performance of each model being separately compared using different metrics, rather than using only a single evaluation metric. The specific metrics that are used for the evaluation are configurable and may vary from one embodiment to another.

After comparing the performance of each of the models, it is determined whether any of the challenger models shows improved performance over that of the champion model. If so, the challenger model with the greatest performance may be promoted to replace the champion model. In some embodiments, it may be desirable to replace the champion model only if the performance of the challenger model exceeds that of the champion model by a predetermined amount. In other words, if the challenger model has only slightly greater performance than the champion model, the overhead cost associated with replacing the champion model may outweigh the performance improvement, in which case the challenger model may not be promoted.

Confidence Driven Workflow (CDW) Labelers

A CDW is a labeler that encapsulates a collection of labelers of the same arity which are consulted in sequence until a configured confidence threshold on the answer is reached. At a high level, multiple agreeing judgments about the same labeling request drive up confidence in the answer. On the other hand, a dissenting judgment decreases confidence. Embodiments of CDW labelers are discussed in U.S. Patent Application Publication No. US 2021/0042577, entitled “Confidence-Driven Workflow Orchestrator for Data Labeling,” which is hereby fully incorporated herein by reference for all purposes.

The configuration for a CDW labeler can include, for example, an indication of the constituent labelers. The CDW configuration for a constituent labeler may indicate if the labeler should be treated as a blind judgment labeler or an open judgment labeler. As will be appreciated, the same labeling request may be resubmitted to a labeler as part of a CDW. For example, the same labeling request may be submitted to a human labeler for labeling by two different labeler instances. The CDW configuration of a constituent labeler may limit the number of times the same labeling request can be submitted to the labeler as part of a CDW.

The CDW configuration may thus be used to configure the workflow orchestrator of a CDW labeler.

Conditioning Components

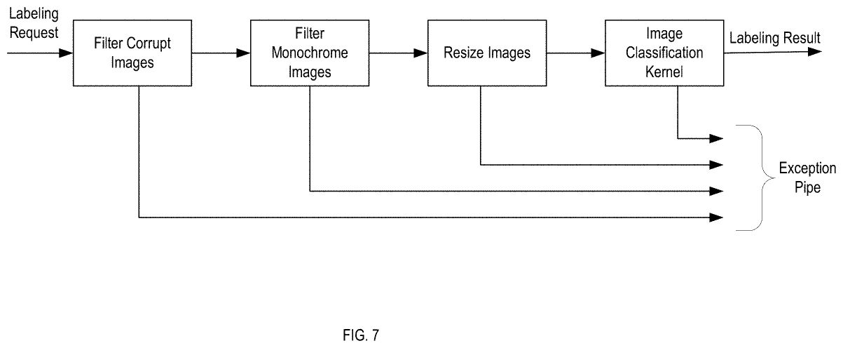

As discussed above, labelers can be composed internally of a core processing kernel surrounded by a conditioning layer, which can include input conditioning, successful output conditioning, and exception output conditioning. The conditioning layer can be constructed by arranging conditioning components (e.g., conditioning components 112) into pipelines according to a labeler's configuration. An example image classification input conditioning pipeline and kernel core logic for an image classification labeler is illustrated in FIG. 7.

Conditioning components perform operations such as data transformation, filtering, and (dis)aggregation. Similar to labelers, the conditioning component may have data input pipes, data output pipes, and exception pipes, but while labelers produce a labeling result from a labeling request, conditioning components simply perform input conditioning, output conditioning, or interstitial conditioning.

In some cases, conditioning components can be used to decompose an input request. For example, in some use cases, the overall labeling request can be decomposed into a collection of smaller labeling requests, all of the same type. This type of decomposition can be achieved within a single labeler using transformers in the conditioning layer. An example of this is classifying frames in a video. It is generally much easier to train a model to classify a single frame image than to classify all the frames in a variable-length video in a single shot. In this case, the data conditioning layer can be configured with a splitter to decompose the video into frames, run each frame through an ML image classification kernel, and combine the output per video.

The splitter can be implemented in the conditioning layer on the input pipe and training pipe of the labeler and is configured to split the video into individual frames. The label+confidence aggregator is implemented in the conditioning layer on the output pipe and aggregates the labels and confidences for the individual frames to determine a label and confidence for the video.

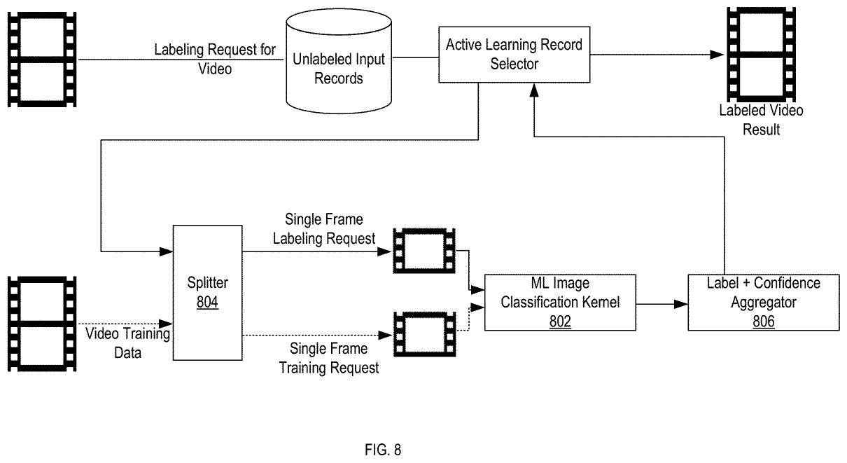

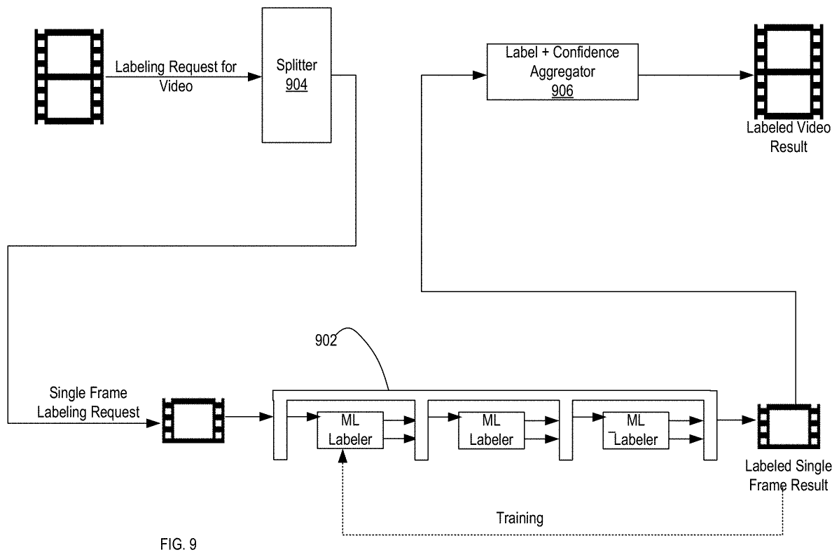

FIG. 8, for example, is a diagrammatic representation of a portion of one embodiment of an ML labeler for classifying a video. In the embodiment illustrated, a splitter 804 that decomposes video input into individual frames is implemented in the conditioning layer on the input pipe and training pipe. A label and confidence aggregator 806 is implemented in the conditioning layer on the output pipe. When a labeling request or training request is received with respect to a video, splitter 804 decomposes the video into frames and sends labeling requests or training requests to the image classification kernel 802 on a per-frame basis. Label and confidence aggregator 806 aggregates inferences and confidences output by image classification kernel 802 for the individual frames to determine a label and confidence for a video. FIG. 9 similarly illustrates a splitter 904 and aggregator 906 implemented in the conditioning layer for a CDW labeler 902.

In addition, or in the alternative, it may be desirable to decompose the output label space. For example, when the output label space is too large to feasibly train a single ML model on the entire problem, the label space can be broken into shards, and a more focused ML labeler assigned to each shard. Consider a use case for localizing and classifying retail products in an image where there are hundreds of possible product types. In such a case, the label space may be carved up by broader product categories.

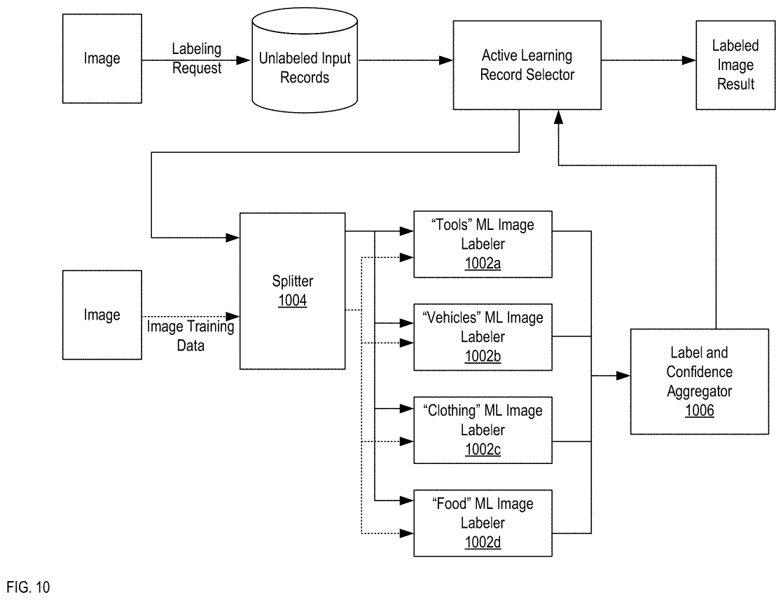

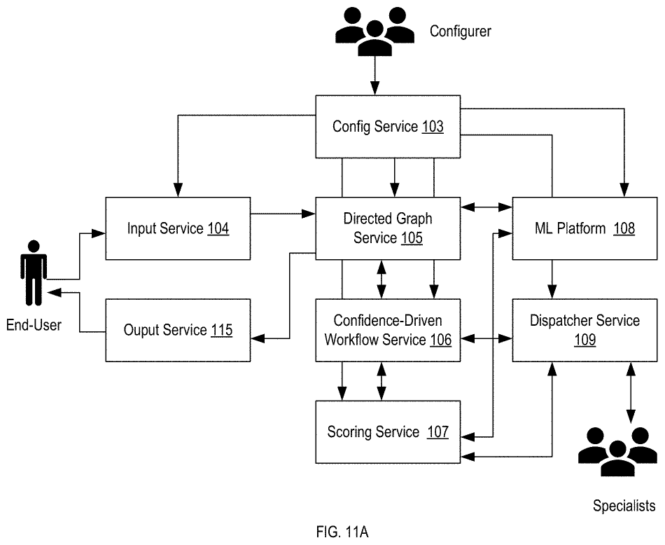

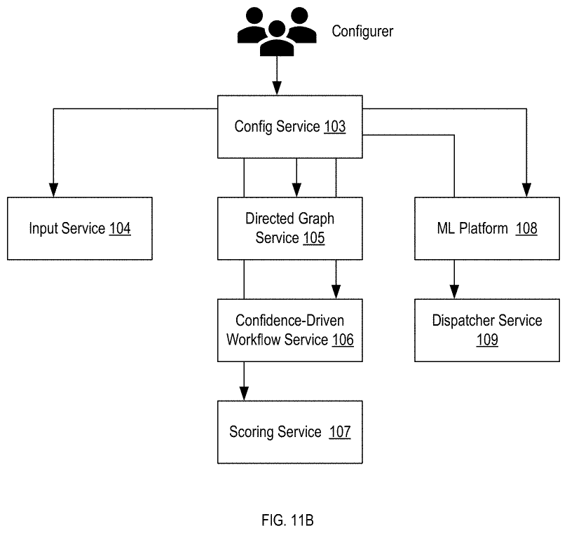

FIG. 10 is a diagrammatic representation of a portion of one embodiment of an ML labeler that includes multiple internal ML labelers. In the embodiment illustrated, a splitter 1004 is implemented in the conditioning layer on the input pipe and training pipe. Here the splitter splits a request to label an image (or image training data) into requests to constituent ML labelers 1002a, 1002b, 1002c, 1002d, where each constituent ML labeler is trained for a particular product category. For example, splitter 1004 routes the labeling request to i) labeler 1002a to label the image with any tools that labeler 1002a detects in the image, ii) labeler 1002b to label the image with any vehicles that labeler 1002b detects in the image, iii) labeler 1002c to label the image with any clothing items that labeler 1002c detects in the image, and iv) labeler 1002d to label the image with any food items that labeler 1002d detects in the image. A label and confidence aggregator 1006 is implemented in the conditioning layer on the output pipe to aggregate the inferences and confidences output by labelers 1002a, 1002b, 1002c, and 1002d to determine the label(s) and confidence(s) applicable to the image.

Thus, a conditioning component may result in fan-in and fan-out conditions in a directed graph. For example, FIG. 10 involves two fan-out points and one fan-in point:
labeling request fan-out to route the same labeling request to each constituent product area labeler;
labeling result fan-in to assemble labeling results from each constituent labeler into an overall labeling result;
training data fan-out to split the training data labels by product type, and route the appropriate label sets to the correct constituent labelers

Splitting or slicing can be achieved by label splitter components implemented in the respective conditioning pipelines. Fan-out can be configured by linking several labelers' request pipes to a single result pipe of a conditioning component. Fan-in can be achieved by linking multiple output pipes to a single input pipe of an aggregator conditioning component. The aggregator can be configured with an aggregation key identifier identifying which constituent data should be aggregated, a template specifying how to combine the inferences from multiple labelers and an algorithm for aggregating the confidences.

System Architecture

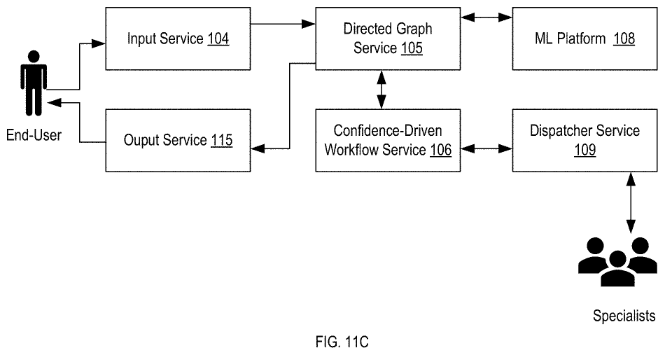

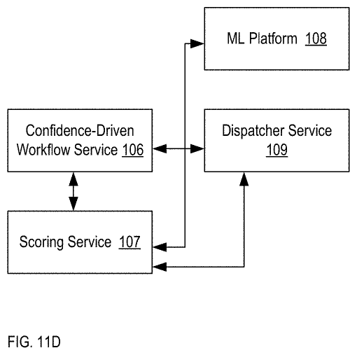

FIG. 11A illustrates one embodiment of configuration, labeling and quality control flows in labeling platform 102, FIG. 11B illustrates one embodiment of a configuration flow in labeling platform 102, FIG. 11C illustrates one embodiment of a labeling flow in labeling platform 102 and FIG. 11D illustrates one embodiment of a quality control flow in labeling platform 102.

Platform 102 includes a configuration service 103 that allows a user (a “configurer”) to create a configuration for a use case. Configuration service 103 bridges the gap between a use case and labeling graph. According to one embodiment, configuration service 103 attempts to adhere to several principles:
It should be easy to specify a configuration as a small change from a previous configuration.
It should be hard to make manual errors, omissions, or oversights.
It should be easy to see, visually, the difference in configuration between two use cases.
It should be easy to automatically assert and verify basic facts about the configuration: number of features used, transitive closure of data dependencies, etc.
It should be possible to detect unused or redundant settings.
It should be easy to test the impact of configuration decisions.
Configurations should undergo a full code review and be checked into a repository.

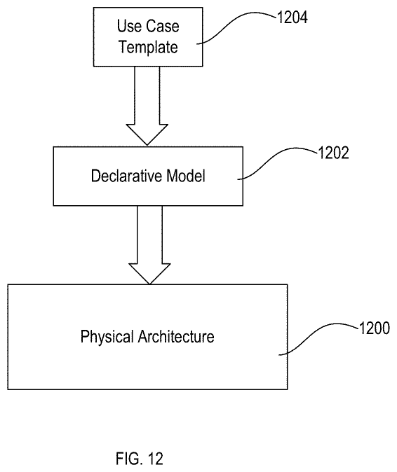

With reference to FIG. 12, configuration can comprise multiple levels of abstraction as illustrated in FIG. 12. The physical configuration is the most explicit level and describes the physical architecture 1200 for a use case. It targets specific runtime infrastructure, configuring things like DOCKER containers, KAFKA topics, cloud resources such as AWS SQS and S3, ML subsystems such as AWS SAGEMAKER and KUBEFLOW, and Data Provenance subsystems such as PACHYDERM (AWS SQS, S3 and SAGEMAKER from Amazon Technologies, Inc., KUBEFLOW from Google, LLC, PACHYDERM from Pachyderm, Inc., DOCKER by Docker, Inc., KAFKA by The Apache Software Foundation) (all trademarks are the property of their respective owners).

In the embodiment of FIG. 12, there is a declarative model layer 1202 above the physical configuration that includes a configuration that is easily read and manipulated by both humans and machines. According to one embodiment, for example, platform 102 supports a declarative language approach to configuration (the declarative domain specific language is referred to herein as DSL). A configuration expressed according to a declarative language can be referred to as a “declarative model” of the use case.

Platform 102 can include use case templates 1204. Use case templates make assumptions regarding what should be included in a use case, and therefore require the least input from the human configurer. Using a use case template, the human user can enter a relatively small amount of configuration. The platform can store a declarative model for a use case, where the declarative model includes configuration assumptions specified by a use case template and the relatively small amount of configuration provided by the human user.

The DSL describes the logical architecture for the use case in a way that is agnostic to which specific set of infrastructure/tools are used at runtime. That is, the DSL specifies the labeling graph at the logical level. While DSL aims to be runtime-agnostic, it will be appreciated that different runtime platforms and tools have different capabilities, and the DSL may be adapted to support some runtime-specific configuration information. Run-time specific configuration in the DSL can be encapsulated into named sections to make the runtime-specificity easily identifiable.

The DSL is expressed in a human and machine-friendly format. One such format, YAML, is used for the sake of example herein. It will be appreciated, however, that a declarative model may be expressed using other formats and languages.

DSL output from the system is in a canonical form. Although order doesn't typically matter for elements at the same level of indentation in a YAML document, a canonical DSL document will have predictable ordering and spacing. One advantage of producing such a canonical representation is to support comparison between different configurations.

Platform 102 can be configured to check DSL (or other configuration format) for correctness. By way of example, but not limitation, configuration service 103 checks for the following errors:
a. Disconnected labeling request input pipe or result output pipe
b. Connected pipes schema mismatch
c. Disagreement between request input pipe schema, internal configuration, and result output pipe schema

To support data provenance, versions of versionable components can be called out explicitly. According to one embodiment, version macros like “latest” are not supported. In such an embodiment, the system can proactively alert an operator when new versions are available.

According to one embodiment, a declarative model defines a configuration for each labeler such that each labeler can be considered self-contained (i.e., the entire logical configuration of the labeler is specified in a single block of DSL (or other identifiable structure) that specifies what data the labeler consumes, how the labeler operates and what data the labeler produces).

The configuration for a labeler may be specified as a collection of key-value pairs (field-value pairs, attribute-value pairs, name-value pairs). According to one embodiment, platform 102 is configured to interpret the names, in context of the structure of the declarative model to configure the labeling graph.

At a high level, the configuration of a labeler in a declarative model may include general labeler configuration (e.g., configuration keys that are not specific to the labeler type). For example, a declarative model may specify the following configuration information for each labeler of a labeling graph:
Name (unique in graph)
Type (type of labeler)
Request pipe (input pipe)
   name (typically a reference to a previously defined result pipe)
   schema
Result pipe (result output pipe)
   name
   schema
Exception pipe
   name
   list of exception types
Docker image reference: The docker image reference is the location from which the docker image file can be downloaded by the platform. As will be appreciated, a docker image is a file which can be executed in Docker. A running instance of an image is referred to as a Docker container. According to one embodiment, the docker image for a labeler contains all of the code for the labeler, a code interpreter, and any library dependencies.

The declarative model may also specify labeler-type specific configuration (e.g., configuration keys that are specific to the labeler type). Labelers may have additional configuration, which varies by type.

For example, other than the generic configuration information that is common to all labelers, the configuration for an executable labeler will be specific to the code. Examples of things that could be configured include, but are not limited to: S3 bucket prefix, desired frame rate, email address to be notified, batch size. The configuration for an executable labeler can include any configuration information relevant to the executable code of the labeler. The configuration of the third-party hosted endpoint can specify which endpoint to hit (e.g., endpoint URL), auth credentials, timeout, etc.

As discussed above, the configuration for an ML labeler can provide the configuration for various functional components of the ML labeler. One example of a DSL block for an ML labeler is illustrated in FIG. 13A and FIG. 13B. As illustrated, the DSL block for the ML labeler includes a general labeler configuration. The General labeler configuration includes a labeler name (e.g., “scene-classification.ml”) (key-value pair 1302), the type of labeler (e.g., machine learning) (key-value pair 1304) and a use case key-value pair 1306. The value of use case key-value pair 1306 indicates if the DSL block was created from a use case template and, if so, the use case template from which it was created. In this example, the DSL block is created from an image-classification use case template.

At label space declaration 1308, the DSL block declares the label space for the ML labeler. In this case, the value of the “labels” key-value pair is expressed as a list of classes.

At input pipe declaration 1310, the DSL block declares the labeling request input pipe for the labeler, assigning the input pipe a name. The DSL block further declares the input pipe schema. For example, the DSL block may include a JSON schema (e.g., according to the JSON Schema specification by the Internet Engineering Task Force, available at https://json-schema.org). The JSON schema may specify, for example, expected fields, field data types, whether a particular field is required (nullable), etc.

At runtime, the directed graph service 105 is aware of the input pipe of the first labeler in the labeling graph for a use case and pushes labeling requests onto that input pipe. The input pipes of subsequent labelers in the graph can be connected to the output pipes of other labelers.

At result pipe declaration 1312, the DSL block declares the output pipe name and schema. For example, the DSL block may include a JSON schema. The JSON schema may specify, for example, expected fields, field data types, whether a particular field is required (nullable), etc. In general, the output pipe of a labeler can be connected to the input pipe of another labeler. For the last labeler in a labeling graph, however, the output pipe is not connected to the input pipe of another labeler.

It can be noted that, in some cases, the connections between output pipes and input pipes are determined dynamically at runtime and are not declared in the declarative model. In other cases, the connections between input pipes and output pipes are declared in the declarative model.

An ML labeler may use training data to train an ML algorithm and, as such, a training pipe can be declared. In the example DSL of FIG. 13A, the training pipe is denoted by a YAML alias for the “training-pipe→name” element of training pipe declaration 1314. In some cases, the training data may be provided by a CDW labeler which contains the ML labeler.

ML labelers can be configured with a number of conditioning pipelines, where each conditioning pipeline comprises one or more conditioning components that transform data on the pipeline. Input conditioning declaration 1316 declares the transforms that are performed on data received on the input pipe and training pipe of the ML labeler. In the example of FIG. 13A, input conditioning declaration specifies that the ML labeler “scene-classification-ml” is to apply an image-resize transform to resize images to 128×128 and to apply a greyscale transform to convert images to greyscale. Thus, when platform 102 implements the “scene-classification-ml” labeler, it will include a resize conditioning component and greyscale conditioning component in the conditioning layer of the labeler, where the resize conditioning component is configured to resize images to 128×128. Using this example then, the request conditioning pipeline 632 and training request and label conditioning pipeline 610 of FIG. 6A would include the configured resize conditioning component and the greyscale conditioning component.

Target conditioning declaration 1318 declares transforms to be applied to the labels specified at 1308. In the example of FIG. 13A, for example, target conditioning declaration 1318 specifies that the labels declared at 1308 are to be transformed to index values. Thus, if platform 102 implements the “scene-classification-ml” labeler according to the configuration of FIG. 13A and FIG. 13B, it will include a label-to-index conditioning component in the conditioning layer for the training pipe, where the label-to-index conditioning component is configured to transform the labels to index values (e.g., outdoor→0, kitchen→1 . . . ). In this example, training request and label conditioning pipeline 610 of FIG. 6A would include the label-to-index conditioning component.

Target de-conditioning declaration 1320 declares transforms to be applied to the output of the ML model. For example, an index value 0-4 output by the ML algorithm for an image can be transformed to the label space declaration at 1308. Thus, if platform 102 implements the “scene-classification-ml” labeler according to the configuration of FIG. 13A and FIG. 13B, it will include an index-to-label conditioning component in the conditioning layer for the output pipe, where the index-to-label conditioning component is configured to transform index values to labels (e.g., 0→outdoor, 1→kitchen . . . ). In this example, the inference conditioning pipeline 634 of FIG. 6A would include the index-to-label de-conditioning.

ML type labelers encapsulate or represent an ML platform, ML framework, and/or ML algorithm. As such, an ML algorithm declaration 1350 declares the ML platform, ML framework, and/or ML algorithm to be used by the ML labeler. Any type of ML algorithm supported by platform 102 (e.g., any ML algorithm supported by the model frameworks of ML platform systems 130 can be specified). Examples of ML algorithms include, but are not limited to: K-Means, Logistic Regression, Support Vector Machines, Bayesian Algorithms, Perceptron, and Convolutional Neural Networks. In the example illustrated, a tensorflow-based algorithm is specified. Thus, an ML labeler created based on the configuration of FIG. 13A and FIG. 13B would represent a model trained using the TensorFlow framework by Google, LLC of Mountain View, Calif. (TENSORFLOW is a trademark of Google, LLC).

It can be noted that while FIG. 13B only specifies a single ML algorithm, other embodiments may specify multiple ML algorithms. Models generated using the various algorithms, which may be implemented on multiple platforms, or multiple models generated using the same algorithm (e.g., models trained with different hyper-parameters) can be tested against each other and the best model selected for use by the ML labeler.

Further, ML algorithms may have configurations that can be declared in the DSL block for the ML labeler via named data elements. For example, machine learning models in TensorFlow are expressible as the composition and stacking of relatively simple layers. Thus, a number of layers for the tensorflow-based algorithm is declared at 1352. It will be appreciated, however, that layers may be pertinent to some machine learning models, but not others. As such, a DSL block for an ML labeler using an algorithm that does not use layers may omit the layers data element. Moreover, other ML algorithms may have additional or alternative configuration that can be expressed via appropriately named data elements in DSL.

Training configuration for algorithms can include active learning, hyper-parameter ranges, limits, and triggers. Active learning declaration 1322 is used to configure the active learning records selector of the ML labeler. Active learning attempts to train the machine learning model of the ML labeler to obtain high accuracy as quickly as possible and an active learning strategy is a strategy for selecting records to be labeled (e.g., by an oracle labeler, by the rest of the graph for use as training data for the ML labeler), where the records will be used to train the ML labeler.

Platform 102 may support multiple strategies, such as random, lowest accuracy or other strategies. In the example of FIG. 13A, a “lowest-accuracy” strategy and “batch size” of 512 are specified. During runtime, the active record selector evaluates outstanding accumulated labeling requests in an attempt to identify which of those would be most beneficial to get labeled by the rest of the labeling graph and then use as training records. “Most beneficial” in this context means having the largest positive impact on model quality. Different selection strategies use different methods to estimate expected benefit. Continuing with the example, the “lowest-accuracy” strategy uses the current active model to obtain inferences on the outstanding accumulated labeling requests, sorts those inferences by the model's self-assessed confidence, then sends the 512 (“batch size”) lowest-ranked records on to the rest of the labeling graph. Low confidence on an inference is an indicator that the model has not been trained with enough examples similar to that labeling request. When the platform has determined the final labels for those records, they are fed back into the ML labeler as training data.

Key-value pairs 1353 declare hyper-parameter ranges define the space for experimental hyper-parameter tuning. The hyper-parameter ranges can be used for example to configure experimentation/candidate model evaluation. As will be appreciated, the hyper-parameters used for training an ML algorithm may depend on the ML algorithm.

Training limits 1354 can be declared to constrain the resources consumed by the training process. Training limits may be specified as a limit on the amount of training data or training time limits.

Training trigger declaration 1356 declares triggers that cause platform 102 to train/retrain a model. Examples include, but are not limited to: a sufficient amount of training data has arrived, a specified period of time has passed, quality monitoring metrics dropping below a threshold or drifting by more than a specified amount (e.g., the ML algorithm score determined by the QMS is decreasing).

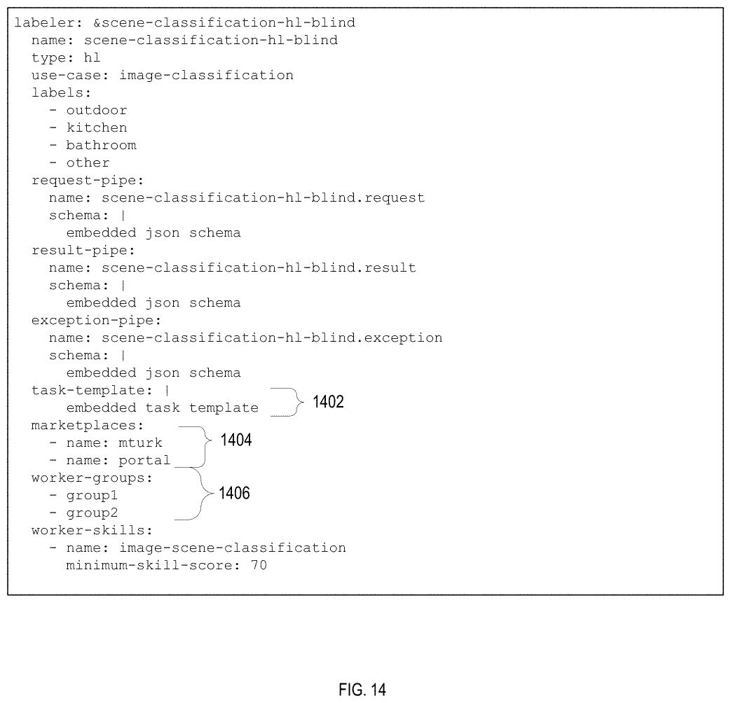

One example of a block of DSL for a human labeler is illustrated in FIG. 14. Here, the labeler type is specified as “hl”, which indicates that the labeler is a human labeler in this context.

A task template declaration 1402 specifies a task template. The task template expresses a user interface to use for presenting a labeling request to a human for labeling and receiving a label assigned by the human to the labeling request. One example of a task template is included in U.S. Patent Application Publication No. US 2021/0192394, entitled “Self-Optimizing Labeling Platform,” which is hereby fully incorporated by referenced herein.

Marketplace declaration 1404 specifies the platform(s) to which tasks from the labeler can be routed. For example, “mturk” represents the Amazon Mechanical Turk marketplace and “portal” represents a workforce portal provided by labeling platform 102. For some types of labeling (e.g., 3D point cloud labeling), highly specialized labeling tools may exist in the marketplace. For various reasons (e.g., cost, time to market), we may opt to integrate those tools into labeling platform 102 as a distinct marketplace as opposed to embedding the tool into our own portal.

Workforce declaration 1406 specifies the defined groups of human specialists to which tasks from the labeler can be routed (i.e., groups of human labeler instances to whom labeling tasks can be routed). If a workforce is declared for a use case, a human specialist must be a member of that workforce for labeling requests associated with the use case to be routed to that human specialist.

Skill declaration 1408 indicates the skills and minimum skill scores that individual workers (human specialists) must have to be routed labeling tasks from the labeler. The QMS may track skills/skill scores for individual human specialists.

A confidence-driven workflow configuration includes a list of constituent labelers that participate in the CDW. Each member of the list specifies an alias to the labeler definition, as well as CDW-specific metadata (e.g., previous result injection, max requests, and cost).

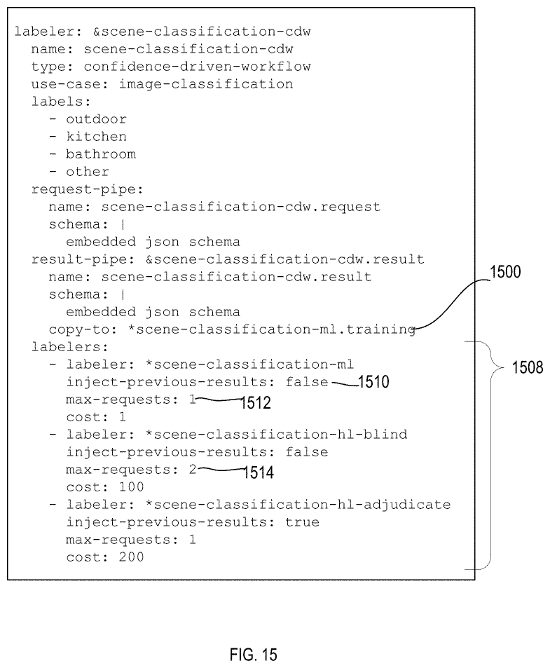

One example of a block of DSL for a CDW labeler is illustrated in FIG. 15. It can be noted that the result-pipe configuration for the CDW labeler includes key-value pair 1500 indicating that, at runtime, labeled results on the output pipe of the scene-classification-CDW labeler are copied to the training pipe of the scene-classification-ml labeler (see, training pipe declaration 1314).

Portion 1508 lists the constituent labelers. The CDW configuration for a constituent labeler may indicate if the labeler should be treated as a blind judgment labeler or an open judgment labeler. In the illustrated embodiment, for example, the CDW configuration includes an inject-previous results key-value pair (e.g., key-value pair 1510). If the value is false, this indicates that the labeler will be treated as a blind judgment labeler. If the value is true, the labeler will be treated as an open judgment labeler.

As will be appreciated, the same labeling request may be resubmitted to a labeler as part of a CDW. For example, the same labeling request may be submitted to a human labeler for labeling by two different labelers. The CDW configuration of a constituent labeler may limit the number of times the same labeling request can be submitted to the labeler as part of a CDW. For example, key-value pair 1512 indicates that each labeling request is to be submitted only once to the labeler scene-classification-ml, whereas key-value pair 1514 indicates that the same labeling request may be submitted up to two times to the labeler scene-classification-hl-blind. The CDW configuration may thus be used to configure the workflow orchestrator of a CDW labeler.

It can be noted that the foregoing examples of DSL blocks for labelers are provided by way of example, but not limitation. Moreover, DSL blocks can be specified for other labelers or conditioning components.

As discussed above, platform 102 may include use case templates to simplify configuration for end users. Use case templates can make assumptions regarding what should be included in a declarative model for a use case, and thus require minimum input from the human configurer. The platform can store a declarative model for a use case, where the declarative model includes configuration assumptions specified by a use case template and the relatively small amount of configuration provided by the human user.

For common use cases, there are three main categories of configuration: elements that are always configured, elements that are commonly configured, and elements that are rarely configured. According to one embodiment, use case templates define default values for commonly or rarely configured elements including (but not limited to):
Media characteristics
   Size
   Format
   Colorspace
Data validation and preparation pipeline
ML characteristics
   Model type
   Model layer config
   Active learning config
   Training trigger config
Confidence driven workflow
   target confidence threshold
   constituent labelers
   human specialist workforces
   task template for human input
   consultation limits

Example use case templates include, but are not limited to: image classification, object localization and classification within images, video frame classification, object localization and classification within videos, natural language processing and entity recognition. According to one embodiment, the always and commonly configured elements are supported with rich UI for customer or customer service reps, while other elements remain hidden.

In cases in which a use case template does not fit an end-user's requirements, a configurer can modify the use case configuration at the DSL level.

The definition and use of use case templates support reuse of common configurations. Config changes can be revision controlled, and the UI can support change history browsing and diff. By constraining the elements that can be changed at this level, the internal consistency of the configuration is much easier to verify.

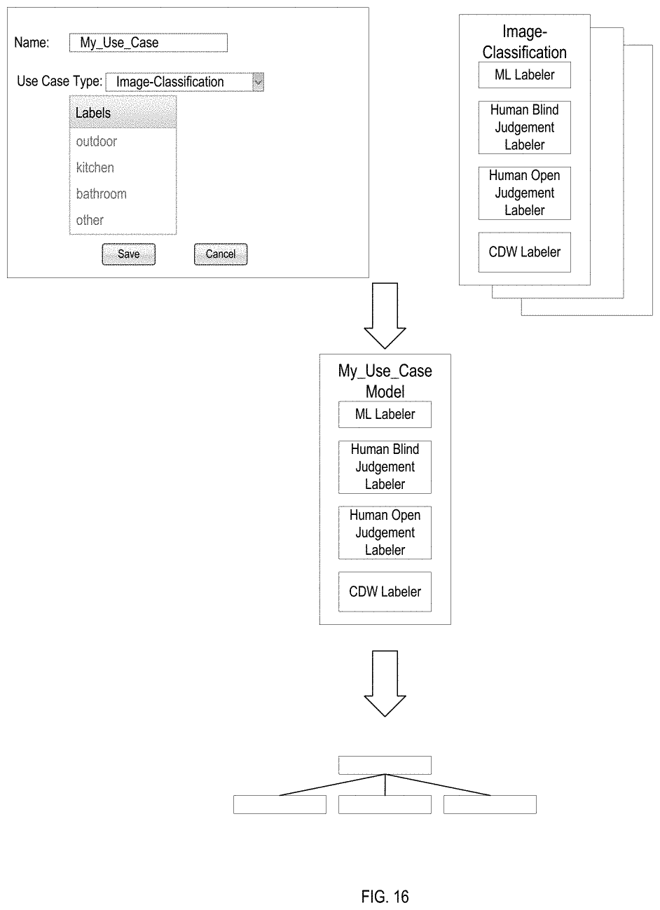

FIG. 16 illustrates one embodiment of configuring a platform for a use case using a use case template. A user, such as a user at a customer of an entity providing the labeling platform or other end-user, may be provided a UI to allow the user to define a new use case. The UI may allow the user to specify a type of use case, where each use case type corresponds to a use case template. In the embodiment illustrated, for example, the use case type “Image-Classification” corresponds to the “Image-Classification” use case template, which includes all the configuration information except for the output labels for an ML labeler, a human labeler (blind judgment), a human labeler (open judgment) and a CDW labeler. Thus, the UI may present tools to allow the user to provide the missing configuration information. Here, the user has populated the labels “outdoor”, “kitchen”, “bathroom”, “other”. In the same interface or a different interface, the user may be provided tools to indicate a data source for training data and/or inference data for the use case.

In this example, a declarative model for “My_Use_Case” is populated with configuration information from the use case template “image-classification” and the additional configuration information provided by the user (e.g., the labels) and stored for the use case. At runtime, the declarative model is used to configure the labeling graph for labeling data or training an ML model associated with “My_Use_Case”. Training and inference using the ML model may be a continuous process, with retraining occurring when training triggers are met.

The ML platforms, frameworks and algorithms used to train the ML models and used for inference are specified based on the configuration set in the use case template and the mappings defined by the adapters. When defining a new use case, the end user does not have to know the specifics of the underlying ML platforms, frameworks, and algorithms.

In some embodiments, the ML model is used for inference in the environment in which it was trained. In another embodiment, the trained ML model may be exported from the environment in which it was trained. For example, an ML model may be trained in SAGEMAKER, packaged as a DOCKER container, and provided to another environment to be deployed for inference. In yet another embodiment, the ML model may be packaged and provided to the end user for deployment to the end user's environment or other environment.

It can be noted that as new platforms, frameworks, or algorithms become available, adapters can be deployed or updated to support the new platforms, frameworks or algorithms where the new or updated adapters map existing DSL values or new DSL values to the new platforms, frameworks, or algorithms. Thus, new platforms, frameworks or algorithms can be readily incorporated into new or existing use case templates or use cases.

The use of DSL and use cases is provided by way of example and configurations for labeling graphs can be provided through any suitable mechanism.

Returning to FIG. 11B, configuration service 103 provides interfaces to receive configurations including cost and confidence constraints. For example, according to one embodiment, configuration service 103 provides a UI that allows a user to create a use case, select a use case template and provide use case specific configuration information for the use case. Configuration service 103 thus receives a configuration for a use case (e.g., using DSL or other format for defining a use case). As discussed above, the use case can include configuration information for labelers and conditioning components. A use case may specify, for example, an endpoint for uploading records, an endpoint at which labeled records are to be accessed, an endpoint at which exceptions are to be accessed, a list of output labels, characteristics of the unlabeled data (e.g., media characteristics, such as size, format, color space), pipelines (e.g., data validation and preparation pipelines), machine learning characteristics (e.g., ML model types, model layer configuration, active learning configuration, training data configuration), confidence driven workflow configuration (e.g., target confidence threshold, constituent labelers, human specialist workforces, task templates for human input), cost and quality constraints or other information.

When an end-user selects to execute a use case, configuration service 103 interacts with input service 104, directed graph service 105, confidence-driven workflow service 106, scoring service 107, ML platform service 108 and dispatcher service 109 to create a workflow as configured by the use case. The workflow may be assigned a workflow id.

With respect to the input service 104, there may be several mechanisms for providing data to be labeled to platform 102, such as a web API, an S3 bucket, a KAFKA topic, etc. Configuration service 103 provides input service 104 with the end point information for the end point to use for receiving records to be labeled. The configuration information may include authentication information for the end point and other information.

Directed graph service 105 creates directed graphs for the labelers of the use case. According to one embodiment, all the directed graphs terminate in a success node or a failure node. When the directed graph terminates at success, the result is sent to the output service 115. The directed graph service 105 creates directed graphs of components to compose labelers (e.g., labelers 110). As discussed above, a given labeler can comprise a number of components conditioning components (e.g., filters, splitters, joiners, aggregators) and functional components (e.g., active record selectors, ML training component, ML model, human labeler instance to which a task interface is to be provided). Directed graph service 105 determines the directed graph of components and their order of execution to create labelers according to the configuration. It can be noted that some labelers can include other labelers. Thus, a particular labeler may itself be a graph inside another labeler graph.

Configuration service 103 passes directed graph service 105 the configurations for the individual human, ML and other labelers of a use case so that directed graph service 105 can compose the various components into the specified labelers. According to one embodiment, configuration service 103 passes labeler DSL blocks to directed graph service 105.

A CDW may include various constituent labelers. For a use case that uses a CDW labeler, directed graph service 105 creates directed graphs for each of the constituent labelers of the CDW and CDW service 106 determines the next constituent labeler to which to route an input request—that is, CDW service 106 provides the workflow orchestrator for a CDW labeler. Configuration service 103 passes CDW service 106 the pool of labelers in a CDW, including static characteristics of those labelers like what their input and output pipes are, constraint information (time, price, confidence). It also passes configuration about where to get non-static information for the labelers, e.g., current consultation cost, current latency and throughput, and current quality. According to one embodiment, configuration service 103 passes the DSL block for a CDW labeler to CDW service 106.

Scoring service 107 can implement the quality monitoring subsystem (QMS) for the use case. In some embodiments, the algorithms used to score labeler instances are configurable as part of a use case. For example, for a use case to label images, where multiple labels can be applied, configuration service 103 may provide the configurer the option to select how results are scored if a labeler instance is partially correct (e.g., if any correct labels are wrong the entire judgment is considered wrong, if at least one label is correct the result is considered correct, etc.). Configuration service 103 can configure scoring service 107 with an indication of the scoring mechanism to use for the use case.

If a labeler for a use case is an ML labeler, configuration service 103 passes model specific information to ML platform service 108 with, for example, the ML algorithm etc. The ML platform service 108 can connect to the appropriate ML model platform.

Dispatcher service 109 is responsible for interacting with human specialists. Dispatcher service 109 routes tasks and task interfaces to human specialists and receives the human specialist labeling output. Configuration service 103 provides configuration information for human labelers to dispatcher service 109, such as the task template, labeler platforms, worker groups, worker skills, and minimum skill scores. For example, configuration service 103 can provide the DSL blocks for human labelers to dispatcher service 109 so that dispatcher service 109 can route tasks appropriately.

Turning to FIG. 11C, input service 104 receives input records to be labeled and generates labeling requests to directed graph service 105. The requests are associated with the workflow id. If a labeling request is being processed by a CDW labeler, directed graph service 105 sends the request to CDW service 106, CDW service determines the next constituent labeler that is to process the input request. Directed graph service 105 executes the directed graph for the selected labeler, and the labeling request is sent to the ML platform service 108 or the dispatcher service 109 depending on whether the labeler is an ML labeler or human labeler. Once the labeling request has been fully processed by the workflow, the labeled result is made available to the end user via output service 115.

As discussed above, scoring service 107 can provide a quality monitoring subsystem. Scoring service 107 is responsible for maintaining the current scores for the labeler instances (e.g., individual models or human specialists). Thus, as illustrated in FIG. 11D, scoring service 107 can communicate scoring information to CDW service 106, ML platform service 108 and dispatcher service 109.

Although the invention has been described with respect to specific embodiments thereof, these embodiments are merely illustrative, and not restrictive of the invention. The description herein (including the disclosure of related U.S. Provisional Application No. 62/950,699) is not intended to be exhaustive or to limit the invention to the precise forms disclosed herein (and in particular, the inclusion of any particular embodiment, feature or function is not intended to limit the scope of the invention to such embodiment, feature, or function). Rather, the description is intended to describe illustrative embodiments, features and functions in order to provide a person of ordinary skill in the art context to understand the invention without limiting the invention to any particularly described embodiment, feature, or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Those skilled in the relevant art will appreciate that embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols. Any particular routine can execute on a single computer processing device or multiple computer processing devices, a single computer processor or multiple computer processors. Data may be stored in a single storage medium or distributed through multiple storage mediums. In some embodiments, data may be stored in multiple databases, multiple filesystems, or a combination thereof.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

What is claimed is:

1. A computer-implemented method for ML platform-agnostic machine learning (ML) inference, the method comprising:
defining a use case type at a labeling platform;
associating, at the labeling platform, a plurality of ML platforms with the use case type;
providing a set of adapters to map an ML platform agnostic format to a plurality of ML platform specific formats;
receiving, at the labeling platform, a use case associated with the use case type, the use case comprising an ML model inference configuration, wherein the ML model inference configuration is ML platform agnostic;
mapping the ML model inference configuration to a first inference environment to configure the first inference environment to use a first ML model, the first inference environment provided by a first ML platform from the plurality of ML platforms; and
routing labeling requests to the first inference environment for labeling by the first ML model.

2. The computer-implemented method of claim 1, wherein the ML model inference configuration comprises a declaration of an ML algorithm and wherein the first inference environment is selected from among several that support the first ML model.

3. The computer-implemented method of claim 1, further comprising:
mapping the ML model inference configuration to a second inference environment to configure the second inference environment to use a second ML model; and
routing labeling requests to the second inference environment for labeling by the second ML model.

4. The computer-implemented method of claim 3, further comprising:
based on a determination that the second ML model is more accurate than the first ML model for the use case, switching using the first inference environment to the second inference environment for inference related to the use case.

5. The computer-implemented method of claim 4, wherein the second inference environment is provided by a second ML platform of the plurality of ML platforms.

6. The computer-implemented method of claim 1, wherein the ML model inference configuration characterizes an expected label space for inferences.

7. The computer-implemented method of claim 1, wherein the ML model inference configuration comprises one or more of: an input conditioning configuration, a target deconditioning configuration, a request pipe configuration, a result pipe configuration, or a target conditioning configuration.

8. A computer program product for machine learning (ML) platform agnostic inference configuration, the computer program product comprising a non-transitory, computer-readable medium having stored thereon a set of computer executable instructions, the set of computer-executable instructions comprising instructions for:
associating a plurality of ML platforms with a defined use case type;
mapping an ML platform agnostic format to a plurality of ML platform specific formats;
receiving a use case associated with the use case type, the use case comprising an ML model inference configuration, wherein the ML model inference configuration is ML platform agnostic;
mapping the ML model inference configuration to a first inference environment to configure the first inference environment to use a first ML model, the first inference environment provided by a first ML platform from the plurality of ML platforms; and
routing labeling requests to the first inference environment for labeling by the first ML model.

9. The computer program product of claim 8, wherein the ML model inference configuration comprises a declaration of an ML algorithm and wherein the first inference environment is selected from among several that support the first ML model.

10. The computer program product of claim 8, wherein the set of computer-executable instructions comprises instructions for:
mapping the ML model inference configuration to a second inference environment to configure the second inference environment to use a second ML model; and
routing labeling requests to the second inference environment for labeling by the second ML model.

11. The computer program product of claim 8, wherein the set of computer-executable instructions comprises instructions for:
based on a determination that the second ML model is more accurate than the first ML model for the use case, switching using the first inference environment to the second inference environment for inference related to the use case.

12. The computer program product of claim 11, wherein the second inference environment is provided by a second ML platform of the plurality of ML platforms.

13. The computer program product of claim 8, wherein the ML model inference configuration characterizes an expected label space for inferences.

14. The computer program product of claim 13, wherein the ML model inference configuration comprises one or more of: an input conditioning configuration, a target deconditioning configuration, a request pipe configuration, a result pipe configuration, or a target conditioning configuration.

15. A labeling platform comprising:
a use case type;
an association of a plurality of machine learning (ML) platforms to the use case type;
a set of adapters to map an ML platform agnostic format to a plurality of ML platform specific formats;
a processor;
a non-transitory computer readable medium having stored thereon a set of computer executable instructions, the set of computer-executable instructions comprising instructions for:
receiving a use case associated with the use case type, the use case comprising an ML model inference configuration, wherein the ML model inference configuration is ML platform agnostic;
mapping the ML model inference configuration to a first inference environment to configure the first inference environment to use a first ML model, the first inference environment provided by a first ML platform from the plurality of ML platforms; and
routing labeling requests to the first inference environment for labeling by the first ML model.

16. The labeling platform of claim 15, wherein the ML model inference configuration comprises a declaration of an ML algorithm and wherein the first inference environment is selected from among several that support the first ML model.

17. The labeling platform of claim 15, wherein the set of computer-executable instructions comprises instructions for:
mapping the ML model inference configuration to a second inference environment to configure the second inference environment to use a second ML model; and
routing labeling requests to the second inference environment for labeling by the second ML model.

18. The labeling platform of claim 15, wherein the set of computer-executable instructions comprises instructions for:
based on a determination that the second ML model is more accurate than the first ML model for the use case, switching using the first inference environment to the second inference environment for inference related to the use case.

19. The labeling platform of claim 18, wherein the second inference environment is provided by a second ML platform of the plurality of ML platforms.

20. The labeling platform of claim 15, wherein the ML model inference configuration characterizes an expected label space for inferences.

21. The labeling platform of claim 20, wherein the ML model inference configuration comprises one or more of: an input conditioning configuration, a target deconditioning configuration, a request pipe configuration, a result pipe configuration, or a target conditioning configuration.
